(19) United States
(12) Patent Application Publication
(10) Pub. No.: US 2025/0108773 A1
(43) Pub. Date: Apr. 3, 2025

(54) CURTAIN AIRBAG DEVICE

(71) Applicant: TOYODA GOSEI CO., LTD., Kiyosu-shi (JP)

(72) Inventors: Yusaku HIKOSAKA, Aichi-ken (JP); Ryosuke JINNAI, Aichi-ken (JP)

(21) Appl. No.: 18/900,319

(22) Filed: Sep. 27, 2024

(30) Foreign Application Priority Data
Sep. 28, 2023 (JP) 2023-166613
Sep. 28, 2023 (JP) 2023-166763

(51) Int. Cl. B60R 21/232; B60R 21/262

(52) U.S. Cl. CPC B60R 21/232; B60R 21/262

(57) ABSTRACT

A curtain airbag device for a moving body includes a bag body that inflates and deploys in response to inflation gas; and an inner tube that has at least a part arranged in the bag body, is supplied with inflation gas from outside, and controls a flow of the inflation gas into the bag body. The bag body includes a first inflation chamber that alleviates an impact on a protection object in the moving body when being inflated by inflation gas, a first orifice through which inflation gas flowing into the first inflation chamber flows, a first sub chamber that adjusts an inflation way of the first inflation chamber and receives inflation gas, and a second orifice through which inflation gas flowing into the first sub chamber flows. A first inflation chamber opening to discharge inflation gas is formed in the inner tube at a position facing the first orifice.

### CROSS-REFERENCE TO RELATED APPLICATIONS

This application is based on and claims priority under 35 USC 119 from Japanese Patent Application No. 2023-166613 filed on Sep. 28, 2023 and Japanese Patent Application No. 2023-166763 filed on Sep. 28, 2023, the entire content of which is incorporated herein by reference.

### TECHNICAL FIELD

The technique of the present disclosure relates to a curtain airbag device.

### BACKGROUND ART

There is a curtain airbag device in the related art, which protects an occupant when a vehicle is side-collided by another vehicle or rolls over. A curtain airbag device in JP2022-42944A includes an inflator that supplies inflation gas, and an airbag that inflates and deploys between an occupant and a side wall portion of a vehicle from above the side wall portion when being supplied with the inflation gas. The airbag includes a bag body and an inner tube. The bag body includes a connection portion. The inner tube includes a tube body that is arranged in the bag body and has a gas outflow port, and an insertion portion that is arranged in the connection portion of the bag body and into which a part of the inflator is inserted.

Further, in the related art, in a vehicle, a curtain airbag device, which is a protection device for an occupant provided on a side wall portion in a vehicle interior, includes an airbag that is deployed between the side wall portion and the occupant when inflation gas is supplied. To adjust an internal pressure of the airbag, there is a mode in which a sub chamber is provided in the airbag, as disclosed in JP2018-016165A, for example.

A main chamber and the sub chamber in the airbag are portions that inflate during deployment by the inflation gas. The main chamber mainly protects a head of the occupant. The sub chamber, in addition to protecting the occupant, adjusts an internal pressure of the main chamber by being connected to the main chamber.

In recent years, a curtain airbag needs to satisfy required specifications regarding a plurality of parameters such as a distance from a reference position in a vehicle, deployment time, a maximum load, and an energy absorption amount at multiple impact points determined on the airbag. However, for example, when inflation gas is supplied to a bag body at a speed sufficient to inflate the entire bag body at an early stage, a reaction force applied to a protection object is large at a portion of the bag body at which impact to the protection object is to be alleviated, and the required specification regarding the maximum load may not be satisfied. In this way, it is not easy for the curtain airbag to satisfy high-level requirements for a plurality of parameters at each impact point determined on the airbag. A large amount of inflation gas may be supplied to all the impact points to satisfy requirements regarding a plurality of parameters. For this reason, there is room for improvement in configurations of a curtain airbag device.

The main chamber and the sub chamber in the airbag are provided by forming non-inflation portions in the airbag. Specifically, the non-inflation portions are joint parts formed by partially joining two fabrics that constitute the airbag by sewing. The non-inflation portions are formed between the main chamber and the sub chamber to define the main chamber and the sub chamber. Therefore, stress concentration may occur in the non-inflation portions due to inflation of the main chamber and the sub chamber when the airbag is deployed.

### SUMMARY

The technique of the present disclosure may be implemented by the following aspects.

(1) According to an aspect of the technique of the present disclosure, curtain airbag device for a moving body is provided. The curtain airbag device for a moving body includes: a bag body that inflates and deploys when being supplied with inflation gas; and an inner tube that has at least a part arranged in the bag body, is supplied with inflation gas from outside, and controls a flow of inflation gas into the bag body. The bag body includes a first inflation chamber that alleviates an impact on a protection object in the moving body when being inflated by inflation gas, a first orifice through which inflation gas flowing into the first inflation chamber flows, a first sub chamber that adjusts an inflation way of the first inflation chamber and receives inflation gas, and a second orifice through which inflation gas flowing into the first sub chamber flows. The inner tube has a first inflation chamber opening that is arranged in a position facing the first orifice and discharges inflation gas.

In such an aspect, following effects may be obtained by adjusting a magnitude of the first inflation chamber opening of the inner tube and shapes of the first orifice, the second orifice, and the first sub chamber. That is, an amount of inflation gas flowing into the first inflation chamber and an amount of inflation gas flowing into the first sub chamber along with passage of time from a start of supply of the inflation gas may be adjusted. As a result, the inflation way of the first inflation chamber along with passage of time from the start of supply of the inflation gas may be appropriately controlled.

(2) In the curtain airbag device according to the above aspect, the inner tube may further have a first sub chamber opening that is arranged in a position facing the second orifice and discharges inflation gas.

In such an aspect, following effects may be obtained by adjusting magnitudes of the first inflation chamber opening and the first sub chamber opening of the inner tube and shapes of the first orifice, the second orifice, and the first sub chamber. That is, the amount of inflation gas flowing into the first inflation chamber and the amount of inflation gas flowing into the first sub chamber along with passage of time from the start of supply of the inflation gas may be more appropriately adjusted.

(3) In the curtain airbag device according to the above aspect, the bag body may further include a second inflation chamber that alleviates an impact on a protection object in the moving body when being inflated by inflation gas and is arranged forward of the first inflation chamber, and a third inflation chamber that alleviates an impact on a protection object in the moving body when being inflated by inflation gas and is arranged rearward of the first inflation chamber, in which the inner tube further may have a second inflation chamber opening that discharges inflation gas into the second inflation chamber, and a third inflation chamber opening that discharges inflation gas into the third inflation chamber.

In such an aspect, following effects may be obtained by adjusting magnitudes of the second inflation chamber opening and the third inflation chamber opening, in addition to magnitudes of the first inflation chamber opening and the first sub chamber opening of the inner tube and shapes of the first orifice, the second orifice, and the first sub chamber. That is, the amount of inflation gas flowing into the first inflation chamber, an amount of inflation gas flowing into the second inflation chamber, an amount of inflation gas flowing into the third inflation chamber, and the amount of inflation gas flowing into the first sub chamber may be adjusted. As a result, inflation ways of the first inflation chamber, the second inflation chamber, and the third inflation chamber may be appropriately controlled.

(4) In the curtain airbag device according to the above aspect, the bag body may further include a communication orifice that allows communication between the first inflation chamber and the second inflation chamber, a second sub chamber that receives inflation gas and is connected to the first inflation chamber and has a volume smaller than a volume of the first sub chamber, and second sub chamber orifice through which inflation gas flowing into the second sub chamber flows and that is arranged on a side opposite to the first orifice relative to the communication orifice.

In such an aspect, the inflation ways of at least the first inflation chamber and the second inflation chamber may be more appropriately controlled by adjusting a magnitude and an arrangement of the communication orifice, a magnitude and an arrangement of the second sub chamber, and a magnitude and an arrangement of the second sub chamber orifice.

(5) In the curtain airbag device according to the above aspect, the first inflation chamber may be located closer to a support pillar supporting at least one of a roof of the moving body and a door of the moving body than the second inflation chamber and the third inflation chamber may be in a front-rear direction of the moving body.

In such an aspect, the protection object in the moving body may be prevented from colliding with the support pillar by appropriately controlling the inflation way of the first inflation chamber.

(6) In the curtain airbag device according to the above aspect, a length of the first sub chamber along a flow direction of inflation gas may be larger than a width of the second orifice, and a length of the second sub chamber along a flow direction of inflation gas may be larger than a width of the second sub chamber orifice.

With such an aspect, the inflation ways of the first inflation chamber and the second inflation chamber may be appropriately controlled for a longer period of time compared with a mode in which a length of each sub chamber is smaller than a width of each sub chamber orifice.

(7) In the curtain airbag device according to claim 2, a length of the first sub chamber along a flow direction of inflation gas may be larger than a width of the second orifice.

With such an aspect, the inflation way of the first inflation chamber may be appropriately controlled for a longer period of time compared with a mode in which the length of the first sub chamber is smaller than the width of the second orifice.

(8) In the curtain airbag device according to the above aspect, the first sub chamber may have a first part extending rearward from a position downward of the inner tube, a second part arranged downward of the first part and extending rearward from a position downward of the inner tube, and a third part connecting a rear end of the first part and a rear end of the second part.

With such an aspect, a length of the first sub chamber may be ensured and an inflation way of the first inflation chamber may be appropriately controlled for a long time, and a protection object in the moving body may be received by the first sub chamber in a wide range in a front-rear direction and an upper-lower direction.

(9) According to another aspect of the present disclosure, there is provided a curtain airbag device for a moving body. The curtain airbag device includes: a bag body that inflates and deploys when being supplied with inflation gas. The bag body includes a plurality of non-inflation portions that serve as portions to which fabrics that constitute the bag body are joined, an inflation chamber serving as an inflation portion and a sub chamber respectively surrounded by one or more non-inflation portions among the plurality of non-inflation portions, a plurality of orifices through which inflation gas to be received in the inflation chamber or the sub chamber flows, and one or more communication flow paths that allow communication between the inflation chamber and the sub chamber. The inflation chamber alleviates an impact on a protection object resulting from coming into contact with the protection object in the moving body by inflating when being supplied with inflation gas. The sub chamber adjusts an inflation way of the inflation chamber by receiving inflation gas. The plurality of orifices include one or more sub chamber orifices that allow communication with the communication flow paths. The plurality of non-inflation portions include a partition non-inflation portion that partitions the inflation chamber and the sub chamber and is longer than a width of the sub chamber orifice.

With such an aspect, when the bag body is deployed, a force applied to the partition non-inflation portion may be received by the entire partition non-inflation portion, which is longer than the width of the sub chamber orifice. Therefore, stress concentration is less likely to occur in the partition non-inflation portion compared with a mode in which the partition non-inflation portion has a width shorter than the width of the sub chamber orifice, for example, a mode in which the main chamber and the sub chamber are partitioned by a plurality of dot-shaped or island-shaped non-inflation portions.

(10) In the curtain airbag device according to the above aspect, the partition non-inflation portion may further include, at an end part of the partition non-inflation portion, a bifurcation section that bifurcates, and an arc-shaped section that connects respective distal ends of the bifurcation section.

With such an aspect, stress concentration is less likely to occur in the end part of the partition non-inflation portion compared with a mode in which the end part of the partition non-inflation portion does not include a closed portion formed by the arc-shaped section and the bifurcation section.

(11) In the curtain airbag device according to the above aspect, the sub chamber may have only one opening, and the sub chamber orifice may function as the opening of the sub chamber.

With such an aspect, an amount of inflation gas that may flow into the sub chamber is limited by a magnitude of the sub chamber. That is, an amount of inflation gas flowing out of the main chamber is also limited. Therefore, the curtain airbag device of the present disclosure may easily adjust an internal pressure of the main chamber by adjusting the magnitude of the sub chamber. Therefore, the curtain airbag device of the present disclosure may more effectively alleviate the impact on the protection object.

(12) In the curtain airbag device according to the above aspect, the communication flow path may be arranged rearward of the inflation chamber and functions as the inflation portion.

With such an aspect, a volume of the communication flow path is larger than that in a case in which the communication flow path functions only as a flow path for the inflation gas. That is, a flow of the inflation gas between the main chamber and the sub chamber is moderated. Therefore, the curtain airbag device of the present disclosure may alleviate the impact on the protection object by moderating a pressure fluctuation in the main chamber resulting from coming into contact with the protection object.

(13) In the curtain airbag device according to the above aspect, the bag body may further include a first inflation chamber orifice that serves as an opening of the inflation chamber and allows communication with the communication flow path, among the plurality of orifices, and a width of the first inflation chamber orifice is larger than the width of the sub chamber orifice.

In such an aspect, the inflation gas in the main chamber flows out toward the sub chamber more easily than in a case in which the width of the first inflation chamber orifice is smaller than the width of the sub chamber orifice. Therefore, the curtain airbag device of the present disclosure may alleviate the impact by easily adjusting a pressure in the main chamber.

(14) In the curtain airbag device according to the above aspect, the bag body may further include a first non-inflation portion that partially partitions the communication flow path serving as the inflation portion and the inflation chamber, among the plurality of non-inflation portions, a body opening to which inflation gas may be supplied, and a second inflation chamber orifice that allows communication with the body opening and is partially defined by the first non-inflation portion, among the plurality of orifices, and a width of the second inflation chamber orifice may be larger than the width of the first inflation chamber orifice.

With such an aspect, the inflation gas flows into the main chamber from the body opening more easily than in a case in which the width of the second inflation chamber orifice is smaller than the width of the first inflation chamber orifice. Therefore, the main chamber may be more easily deployed.

(15) In the curtain airbag device according to the above aspect, the body opening may be an innermost part of the bag body in a flow path connecting outside and inside of the bag body, and is defined by a non-inflation portion outside the bag body, and the first non-inflation portion may have a shape in which a magnitude of the body opening along a width direction is larger than a magnitude along a direction perpendicular to the width direction.

In such an aspect, the inflation gas discharged from the body opening flows in a direction perpendicular to the width direction of the body opening. Therefore, since the first non-inflation portion has a large shape in a direction along a flow of the inflation gas, a load due to the inflation gas may be reduced.

(16) In the curtain airbag device according to the above aspect, the bag body may further include orifices other than the first inflation chamber orifice and the sub chamber orifice as openings of the communication flow paths serving as the inflation portions, among the plurality of orifices, and the other orifices may allow communication with the body opening. With such an aspect, the inflation gas for inflating the sub chamber bifurcates and flows into the first inflation chamber orifice serving as the opening of the main chamber and into the other orifices. That is, the pressure in the main chamber is reduced by reducing an amount of inflation gas passing through the main chamber. Therefore, a stress generated in the partition non-inflation portion is reduced by reducing a load applied to the partition non-inflation portion.

(17) In the curtain airbag device according to the above aspect, the communication flow path serving as the inflation portion may alleviate an impact on the protection object resulting from coming into contact with the protection object, and the bag body may further include an additional sub chamber that adjusts an inflation way of the communication flow path serving as the inflation portion in response to receiving inflation gas, and a central orifice that is arranged in a position facing the body opening and discharges inflation gas to the communication flow path serving as the inflation portion and the additional sub chamber, and
a second non-inflation portion that partially partitions the communication flow path serving as the inflation portion and the additional sub chamber, among the plurality of non-inflation portions, and an end part of the second non-inflation portion may define a narrowest part of the other orifices and is arranged within a width range of the central orifice when viewed along a flow direction of inflation gas flowing through the central orifice.

With such an aspect, the inflation gas flowing through the central orifice flows into the communication flow path serving as the inflation portion and into the additional sub chamber through the second non-inflation portion. That is, the inflation gas is more likely to flow into portions other than the inflation portion connected to the main chamber, so that the pressure in the main chamber is reduced. Therefore, the stress generated in the partition non-inflation portion is reduced by reducing the load applied to the partition non-inflation portion.

(18) In the curtain airbag device according to the above aspect, the end part of the second non-inflation portion may be formed in a convex shape toward the first non-inflation portion.

With such an aspect, the inflation gas discharged from the central orifice is more likely to flow into the additional sub chamber along the convex-shaped second non-inflation portion. That is, the pressure in the main chamber is further reduced. Therefore, the stress generated in the partition non-inflation portion is reduced by reducing the load applied to the partition non-inflation portion.

The technique of the present disclosure may be implemented by various aspects other than the curtain airbag device. For example, the present disclosure may be implemented by aspects of a method for manufacturing a curtain airbag device, a design method of a curtain airbag device, a computer program implementing a method for controlling a curtain airbag device, and a non-transitory recording medium storing the computer program.

### BRIEF DESCRIPTION OF DRAWINGS

FIG. 1 is a schematic view illustrating configurations of a curtain airbag device 100 for a vehicle MV;

FIG. 2 is a schematic view illustrating a section of a bag body 110 in a folded state;

FIG. 3 is a plan view illustrating a configuration of an inner tube 120;

FIG. 4 is a schematic view illustrating details of an internal configuration of the bag body 110;

FIG. 5 is a schematic view illustrating details of configurations of a first inflation chamber MC1, a first sub chamber SC1, and a second sub chamber SC2;

FIG. 6 is a photograph illustrating a state in which the bag body 110 completes inflation and deployment;

FIG. 7 is a photograph illustrating a state in which the bag body 110 starts inflation and deployment but before completion;

FIG. 8 is a schematic view illustrating configurations of a curtain airbag device 100b according to a second embodiment;

FIG. 9 is a schematic view illustrating configurations of a curtain airbag device 100c according to a third embodiment;

FIG. 10 is a schematic view illustrating a curtain airbag device according to a fourth embodiment in a vehicle;

FIG. 11 is a schematic view illustrating a bag body;

FIG. 12 is an enlarged view of the bag body;

FIG. 13 is a photograph illustrating a folded state of the curtain airbag device;

FIG. 14 is a photograph illustrating mid-deployment of the curtain airbag device;

FIG. 15 is a photograph illustrating mid-deployment of the curtain airbag device; and

FIG. 16 is a photograph illustrating a state in which the bag body completes inflation.

### DESCRIPTION OF EMBODIMENTS

### A. First Embodiment

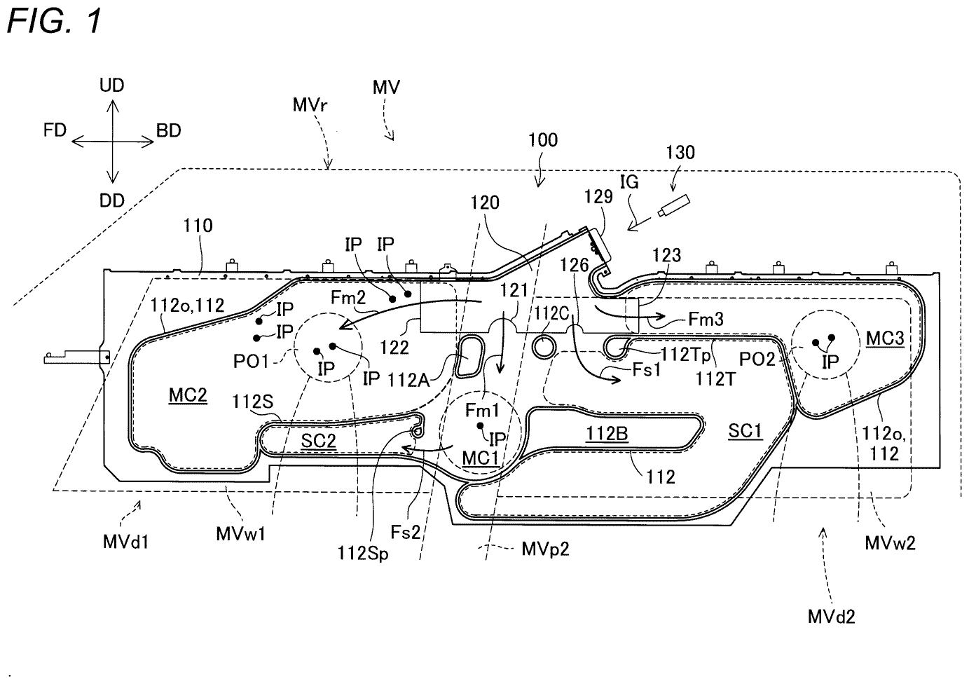

FIG. 1 is a schematic view illustrating configurations of a curtain airbag device 100 for a vehicle MV. The curtain airbag device 100 illustrated in FIG. 1 is deployed along a right side wall of the vehicle MV. In the vehicle MV, a curtain airbag device having a configuration substantially symmetrical to the curtain airbag device 100 illustrated in FIG. 1 is deployed along a left side wall of the vehicle MV. FIG. 1 illustrates an internal structure of the curtain airbag device 100. In FIG. 1, an outline of the vehicle MV is indicated by a broken line.

In FIG. 1, an upward direction is indicated by an arrow UD, and a downward direction is indicated by an arrow DD. A forward direction of the vehicle MV is indicated by an arrow FD, and a rearward direction of the vehicle MV is indicated by an arrow BD. Arrows UD, DD, FD, and BD illustrated in other drawings correspond to the arrows UD, DD, FD, and BD in FIG. 1. An upper-lower direction, a front-rear direction, and a left-right direction referred to in this specification are an upper-lower direction, a front-rear direction, and a left-right direction of the vehicle MV serving as a moving body. In this specification, the upper-lower direction is indicated by a reference sign “UD/DD”. The front-rear direction is indicated by a reference sign “FD/BD”.

A protection object PO1 illustrated in FIG. 1 is an occupant sitting on a front seat of the vehicle MV (see a middle left portion and a middle right portion in FIG. 1). A protection object PO2 illustrated in FIG. 1 is an occupant sitting on a rear seat of the vehicle MV. When an impact is applied to the vehicle MV, the curtain airbag device 100 deploys from a ceiling of the vehicle MV along the side wall and windows of the vehicle MV. The protection objects PO1 and PO2 in the vehicle MV relatively move toward the side wall and the windows of the vehicle MV due to the impact applied to the vehicle MV and inertial forces thereof. The protection objects PO1 and PO2 do not directly collide with the side wall or the windows but collide with the deployed curtain airbag device 100. As a result, the impact applied to the protection objects PO1 and PO2 is alleviated.

The curtain airbag device 100 includes a bag body 110, an inner tube 120, and an inflator 130.

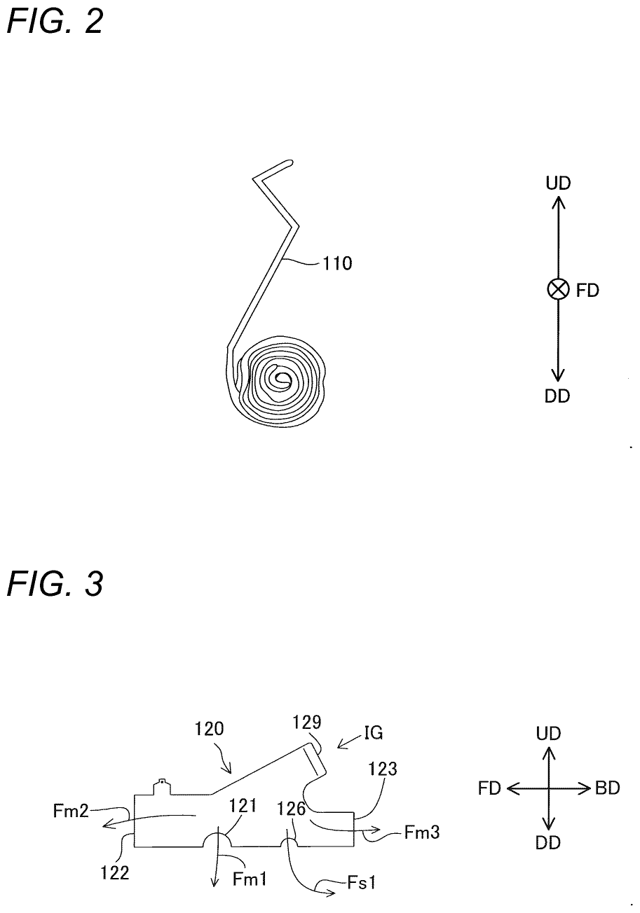

FIG. 2 is a schematic view illustrating a section of the bag body 110 in a folded state. When being supplied with inflation gas IG, the bag body 110 inflates and deploys from the state illustrated in FIG. 2 (see an upper left portion in FIG. 1). Shapes and positional relationships of portions of the bag body 110 of the curtain airbag device 100 when expanded will be described later.

The bag body 110 is constituted by two pieces of substantially rectangular cloth made of polyethylene terephthalate and stacked and sewn together. In FIG. 1, a sewn portion of the bag body 110 is referred to as a sewn portion 112. In FIG. 1, the sewn portion 112 defining an outer edge of a part of the bag body 110 into which the inflation gas IG is introduced is illustrated as an outer edge sewn portion 1120. A configuration of the bag body 110 will be described in detail later.

FIG. 3 is a plan view illustrating a configuration of the inner tube 120. The inner tube 120 is supplied with the inflation gas IG from outside, and supplies the inflation gas IG into the bag body 110 (see an upper central portion in FIG. 1). The inner tube 120 controls a flow of the inflation gas IG in the bag body 110 when supplying the inflation gas IG into the bag body 110. The inner tube 120 has a bifurcating tubular structure. A distal end portion of a bifurcating tube of the inner tube 120 is arranged outside the bag body 110 (see the upper central portion in FIG. 1). The other part of the inner tube 120 is arranged in the bag body 110.

The inner tube 120 is constituted by two pieces of cloth made of polyethylene terephthalate and stacked and sewn together. The inner tube 120 has a first inflation chamber opening 121, a second inflation chamber opening 122, a third inflation chamber opening 123, a first sub chamber opening 126, and a connection opening 129.

The connection opening 129 is located at a distal end of a part of the inner tube 120 that is arranged outside the bag body 110 (see the upper central portion in FIG. 1). The connection opening 129 is located at one distal end of the bifurcating tube of the inner tube 120. The connection opening 129 is connected to the inflator 130. In FIG. 1, the connection opening 129 and the inflator 130 are illustrated separately to facilitate technique understanding. The connection opening 129 receives the inflation gas IG supplied from the inflator 130 into the inner tube 120 (see the upper central portion in FIG. 1 and an upper right portion in FIG. 3).

The first inflation chamber opening 121, the second inflation chamber opening 122, the third inflation chamber opening 123, and the first sub chamber opening 126 are located in the part of the inner tube 120 that is arranged in the bag body 110 (see a lower portion in FIG. 3 and the upper central portion in FIG. 1). The first inflation chamber opening 121, the second inflation chamber opening 122, the third inflation chamber opening 123, and the first sub chamber opening 126 discharge the inflation gas IG from the inner tube 120.

The second inflation chamber opening 122 is located in a front end of the inner tube 120 and opens forward (see a left portion in FIG. 3). The second inflation chamber opening 122 discharges the inflation gas IG to a second inflation chamber MC2 of the bag body 110 (see an arrow Fm2 in FIGS. 1 and 3). The second inflation chamber MC2 of the bag body 110 will be described in detail later.

The third inflation chamber opening 123 is located in a rear end of the inner tube 120 and opens rearward (see the left portion in FIG. 3). The third inflation chamber opening 123 is located in another distal end of the bifurcating tube of the inner tube 120. The third inflation chamber opening 123 discharges the inflation gas IG to a third inflation chamber MC3 of the bag body 110 (see an arrow Fm3 in FIGS. 1 and 3). The third inflation chamber MC3 of the bag body 110 will be described in detail later.

The first inflation chamber opening 121 and the first sub chamber opening 126 are located between the second inflation chamber opening 122 and the third inflation chamber opening 123 in the front-rear direction FD/BD and constantly open downward (see a lower central portion in FIG. 3). The first inflation chamber opening 121 is located in the forward direction FD of the first sub chamber opening 126. The first inflation chamber opening 121 is larger than the first sub chamber opening 126.

The first inflation chamber opening 121 and the first sub chamber opening 126 discharge the inflation gas IG into a connection chamber CC of the bag body 110. Thereafter, the inflation gas IG discharged from the first inflation chamber opening 121 flows mainly into a first inflation chamber MC1 (see an arrow Fm1 in FIGS. 1 and 3). The inflation gas IG discharged from the first sub chamber opening 126 mainly flows into a first sub chamber SC1 (see an arrow Fs1 in FIGS. 1 and 3). The connection chamber CC, the first inflation chamber MC1, and the first sub chamber SC1 of the bag body 110 will be described in detail later.

Openings for discharging the inflation gas IG from the inner tube 120 are limited to the first inflation chamber opening 121, the second inflation chamber opening 122, the third inflation chamber opening 123, and the first sub chamber opening 126. As a result, the flow of the inflation gas IG from the inner tube 120 into the bag body 110 is controlled (see Fm1 to Fm3 and Fs1 in FIG. 1).

The inner tube 120 has, in addition to the second inflation chamber opening 122 and the third inflation chamber opening 123 that discharge the inflation gas IG into the inflation chambers MC2 and MC3, the first inflation chamber opening 121 and the first sub chamber opening 126 that discharge the inflation gas IG to a chamber other than the inflation chambers MC2 and MC3. For this reason, it is possible to prevent a situation in which a large amount of inflation gas IG is supplied to the second inflation chamber MC2 and the third inflation chamber MC3 at an early time after start of supply of the inflation gas IG and the second inflation chamber MC2 and the third inflation chamber MC3 inflate largely and apply an excessive reaction force to the protection objects PO1 and PO2.

The inflator 130 is connected to the connection opening 129 of the inner tube 120. The inflator 130 receives a signal from a controller (not illustrated) and ejects the inflation gas IG. The bag body 110 inflates and deploys from the state illustrated in FIG. 2 by the inflation gas IG ejected from the inflator 130 (see FIG. 1).

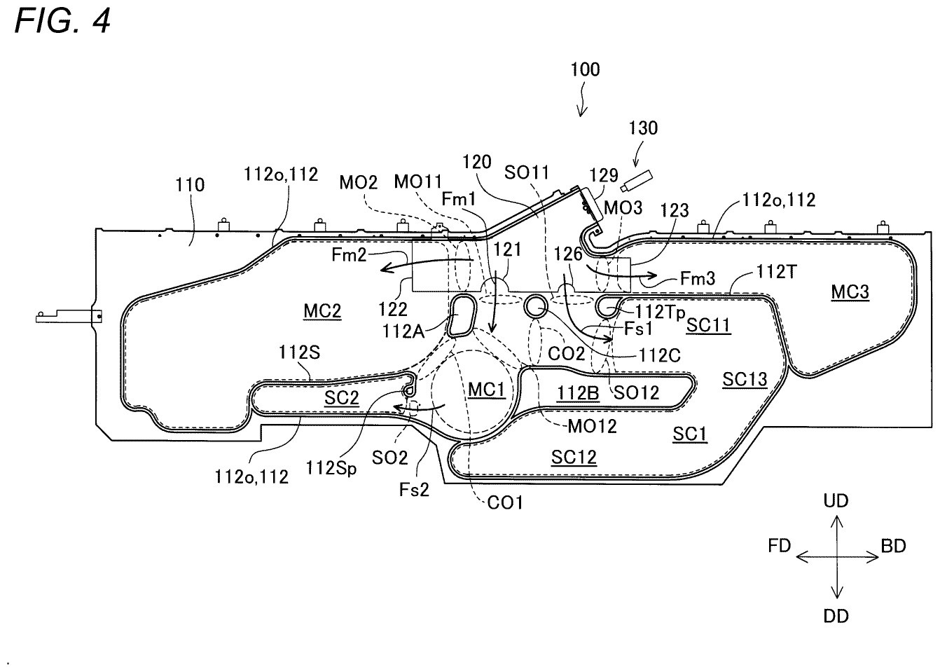

FIG. 4 is a schematic view illustrating details of an internal configuration of the bag body 110. The bag body 110 includes the first inflation chamber MC1, the second inflation chamber MC2, the third inflation chamber MC3, the first sub chamber SC1, a second sub chamber SC2, and the connection chamber CC. The bag body 110 further includes a first non-inflation portion 112A, a second non-inflation portion 112B, a third non-inflation portion 112C, a fourth non-inflation portion 112Sp, and a fifth non-inflation portion 112Tp.

The bag body 110 further includes a first orifice MO11, a second orifice SO11, a first inflation chamber orifice MO12, a second inflation chamber orifice MO2, a third inflation chamber orifice MO3, communication orifices CO1, CO2, a first sub chamber orifice SO12, and a second sub chamber orifice SO2.

In this specification, an “orifice” is a configuration for controlling the flow of the inflation gas IG, in which a sectional area of a flow passage in a section perpendicular to a flow direction of the inflation gas IG is narrower than sectional areas of spaces connected upstream and downstream of the configuration. The orifice defines a relationship between a pressure difference upstream and downstream of the orifice and a flow rate per unit time of a fluid flowing from upstream of the orifice to downstream of the orifice. In the bag body 110, the orifice is defined by the sewn portion 112.

The first inflation chamber MC1 alleviates the impact on the protection objects PO1 and PO2 in the vehicle MV by being inflated by the inflation gas IG (see a lower central portion in FIG. 4). The first inflation chamber MC1 is located closer to a support pillar MVp2 of the vehicle MV than the second inflation chamber MC2 and the third inflation chamber MC3 are in the front-rear direction FD/BD of the vehicle MV.

The support pillar MVp2 of the vehicle MV supports a roof MVr of the vehicle MV and a rear seat door MVd2 of the vehicle MV (see a lower central portion in FIG. 1). The support pillar MVp2 of the vehicle MV further has a function of receiving an impact when the vehicle MV receives the impact from a side surface and preventing an internal space of the vehicle MV from reducing. The support pillar MVp2 has a large thickness to achieve such a function. As a result, the support pillar MVp2 projects into the internal space of the vehicle MV. The support pillar MVp2 has a surface thereof covered with a resin member in the internal space of the vehicle MV. To facilitate technique understanding, FIG. 1 illustrates a window MVw2 provided in the rear seat door MVd2 of the vehicle MV, a front seat door MVd1 of the vehicle MV, and a window MVw1 provided in the door MVd1 (see a lower portion in FIG. 1).

Since the first inflation chamber MC1 is arranged in the above-described position, it is possible for the protection objects PO1 and PO2 in the vehicle MV not to directly collide with the support pillar MVp2 projecting into the internal space of the vehicle MV by appropriately controlling an inflation way of the first inflation chamber MC1.

The inflation gas IG supplied to the connection opening 129 of the inner tube 120 is supplied to the first inflation chamber MC1 through the first inflation chamber opening 121 of the inner tube 120 and the first orifice MO11 and the first inflation chamber orifice MO12 (see the arrow Fm1 in FIG. 4). For this reason, in the curtain airbag device 100, the first inflation chamber MC1 that deploys in a vicinity of the support pillar MVp2 may be inflated early compared with a mode in which the first inflation chamber opening 121 and the first orifice MO11 facing the first inflation chamber opening 121 are not provided. Accordingly, even when the protection objects PO1 and PO2 relatively move toward the support pillar MVp2 due to the impact applied to the vehicle MV, kinetic energy of the protection objects PO1 and PO2 may be more reliably absorbed.

The second inflation chamber MC2 alleviates the impact on the protection object PO1 in the vehicle MV by being inflated by the inflation gas IG (see a middle left portion in FIG. 4 and the middle left portion in FIG. 1). The second inflation chamber MC2 is arranged in the forward direction FD of the first inflation chamber MC1. The phrase “the second inflation chamber MC2 is arranged in the forward direction FD of the first inflation chamber MC1” means that a front end of the second inflation chamber MC2 is located forward of a front end of the first inflation chamber MC1. In the curtain airbag device 100 illustrated in FIG. 1, the second inflation chamber MC2 is located rightward of the front seat of the vehicle MV.

The third inflation chamber MC3 alleviates the impact on the protection object PO2 in the vehicle MV by being inflated by the inflation gas IG (see a middle right portion in FIG. 4 and the middle right portion in FIG. 1). The third inflation chamber MC3 is arranged in the rearward direction BD of the first inflation chamber MC1. The phrase “the third inflation chamber MC3 is arranged in the rearward direction BD of the first inflation chamber MC1” means that a rear end of the third inflation chamber MC3 is located rearward of a rear end of the first inflation chamber MC1. In the curtain airbag device 100 illustrated in FIG. 1, the third inflation chamber MC3 is located rightward of the rear seat of the vehicle MV.

With such a configuration, following effects may be obtained by adjusting magnitudes of the second inflation chamber opening 122 and the third inflation chamber opening 123, in addition to magnitudes of the first inflation chamber opening 121 and the first sub chamber opening 126 of the inner tube 120 and shapes of the first orifice MO11, the second orifice SO11, and the first sub chamber SC1. That is, the amount of inflation gas IG flowing into the first inflation chamber MC1, the amount of inflation gas IG flowing into the second inflation chamber MC2, the amount of inflation gas IG flowing into the third inflation chamber MC3, and the amount of inflation gas IG flowing into the first sub chamber SC1 may be adjusted. As a result, inflation ways of the first inflation chamber MC1, the second inflation chamber MC2, and the third inflation chamber MC3 may be appropriately controlled. The first orifice MO11, the second orifice SO11, and the first sub chamber SC1 will be described in detail later.

In the bag body 110, the inflation chambers MC2 and MC3 that deploy beside seats of the vehicle MV have outer edges defined by the sewn portion 112, and each have one or two orifices as locations in which inside communicates with outside. For this reason, by adjusting shapes of the outer edges of the inflation chambers and shapes of the orifices of the inflation chambers, it is possible to adjust the inflation ways of the inflation chambers along with passage of time from the start of supply of the inflation gas IG.

The first sub chamber SC1 is a space for adjusting inflation ways of the first inflation chamber MC1, the second inflation chamber MC2, and the third inflation chamber MC3 (see the lower central portion in FIG. 4). The first sub chamber SC1 is arranged in the rearward direction BD of the first inflation chamber MC1. The first sub chamber SC1 receives the inflation gas IG. The first sub chamber SC1 is connected to the first inflation chamber MC1. The first sub chamber SC1 and the third inflation chamber MC3 are partitioned by a partition portion 112T of the sewn portion 112 that extends in the front-rear direction FD/BD (see the middle right portion in FIG. 4).

The first sub chamber SC1 includes a first part SC11, a second part SC12, and a third part SC13 (see a lower right portion in FIG. 4). The first part SC11 is a part of the first sub chamber SC1 that extends in the rearward direction BD from a position in the downward direction DD of the inner tube 120. The second part SC12 is arranged in the downward direction DD of the first part SC11. The second part SC12 is a part of the first sub chamber SC1 that extends in the rearward direction BD from a position in the downward direction DD of the inner tube 120. The third part SC13 is a part of the first sub chamber SC1 that connects a rear end of the first part SC11 and a rear end of the second part SC12. The third part SC13 is located in the rearward direction BD of the first inflation chamber MC1.

With such a configuration, it is possible to ensure a length in the first sub chamber SC1 and appropriately control the inflation way of the first inflation chamber MC1 for a long time, and it is possible to receive the protection objects PO1 and PO2 in the vehicle MV by the first sub chamber SC1 in a wide range in the front-rear direction FD/BD and the upper-lower direction UD/DD.

In the first sub chamber SC1, only the first sub chamber orifice SO12 provided in a front end of the first part SC11 is a communication hole that allows communication between inside and outside of the first sub chamber SC1. With such a configuration, the first part SC11 inflates earlier than the second part SC12. As a result, it is possible to ensure a thickness of the bag body 110 in a central part of the bag body 110 at an early time after the start of supply of the inflation gas IG. Thus, the protection objects PO1 and PO2 in the vehicle MV may be effectively protected from the impact.

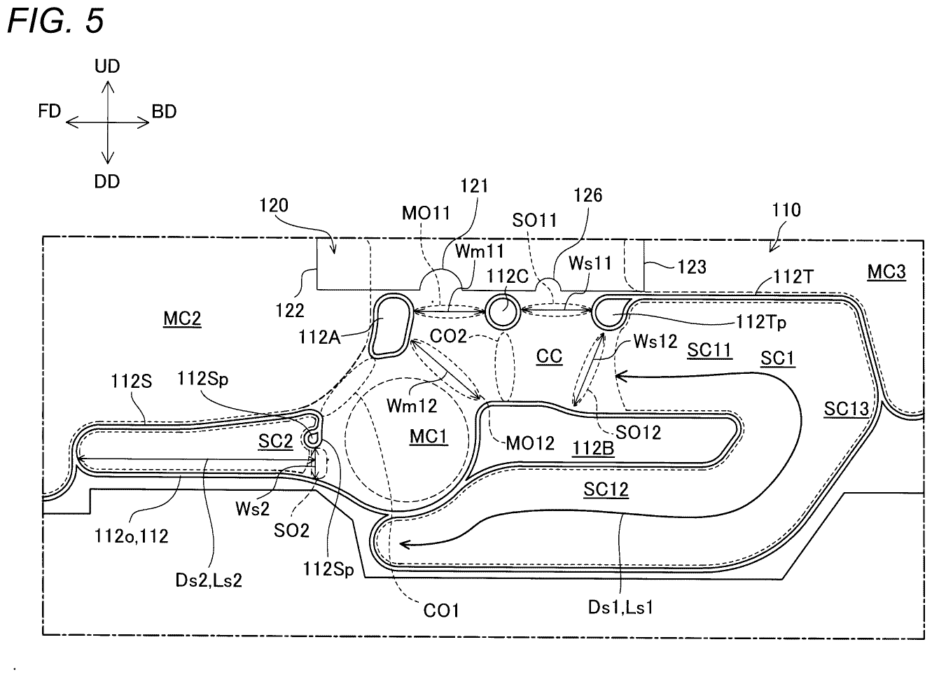

FIG. 5 is a schematic view illustrating details of configurations of the first inflation chamber MC1, the first sub chamber SC1, and the second sub chamber SC2. A length Ls1 of the first sub chamber SC1 along a flow direction Ds1 of the inflation gas IG is larger than a width Ws11 of the second orifice SO11 (see a middle right portion and an upper central portion in FIG. 5). The second orifice SO11 will be described later.

The second sub chamber SC2 is a space for adjusting the inflation way of the first inflation chamber MC1 (see the lower central portion in FIG. 4 and a middle left portion in FIG. 5). The second sub chamber SC2 is arranged in the forward direction FD of the first inflation chamber MC1. The second sub chamber SC2 is connected to the first inflation chamber MC1. The second sub chamber SC2 receives the inflation gas IG from the first inflation chamber MC1. The flow of the inflation gas IG flowing from the first inflation chamber MC1 to the second sub chamber SC2 is indicated by an arrow Fs2 in FIGS. 1 and 4. The second sub chamber SC2 and the second inflation chamber MC2 are partitioned by a partition portion 112S of the sewn portion 112 that extends in the front-rear direction FD/BD (see the middle left portion in FIG. 4). The second sub chamber SC2 has a volume smaller than a volume of the first sub chamber SC1.

A length Ls2 of the second sub chamber SC2 along a flow direction Ds2 of the inflation gas IG is larger than a width Ws2 of the second sub chamber orifice SO2 (see a lower left portion in FIG. 5). The second sub chamber orifice SO2 will be described later.

By configuring the first sub chamber SC1 and the second sub chamber SC2 in this manner, the inflation ways of the first inflation chamber MC1, the second inflation chamber MC2, and the third inflation chamber MC3 may be appropriately controlled for a longer period of time compared with a mode in which a length of each sub chamber is smaller than a width of each sub chamber orifice.

In the bag body 110, the sub chamber SC1 and SC2 have outer edges defined by the sewn portion 112, and each have one orifice as a location in which inside communicates with outside. For this reason, by adjusting shapes and magnitudes of the outer edges of the sub chambers and shapes of the orifices of the sub chambers, it is possible to more appropriately adjust the inflation ways of the inflation chambers along with passage of time from the start of supply of the inflation gas IG.

The connection chamber CC is surrounded by the first non-inflation portion 112A, the second non-inflation portion 112B, the third non-inflation portion 112C, and the fifth non-inflation portion 112Tp (see a middle central portion in FIG. 5). The connection chamber CC is surrounded by the first orifice MO11, the first inflation chamber orifice MO12, the second orifice SO11, and the first sub chamber orifice SO12.

The connection chamber CC circulates the inflation gas IG in the bag body 110. Part of the inflation gas IG supplied to the connection opening 129 of the inner tube 120 flows into the first inflation chamber MC1 via the first orifice MO11, the connection chamber CC, and the first inflation chamber orifice MO12. Part of the inflation gas IG supplied to the connection opening 129 of the inner tube 120 flows into the first sub chamber SC1 through the second orifice SO11, the connection chamber CC, and the first sub chamber orifice SO12.

In the connection chamber CC, an orifice that connects (i) a part in the forward direction FD that is surrounded by the third non-inflation portion 112C, the first orifice MO11, the first non-inflation portion 112A, and the first inflation chamber orifice MO12, and (ii) a part in the rearward direction BD that is surrounded by the third non-inflation portion 112C, the second orifice SO11, the fifth non-inflation portion 112Tp, the first sub chamber orifice SO12, and the second non-inflation portion 112B, is referred to as the communication orifice CO2, and is illustrated in FIG. 5. The communication orifice CO2 is defined by the third non-inflation portion 112C and the second non-inflation portion 112B.

The first non-inflation portion 112A, the second non-inflation portion 112B, the third non-inflation portion 112C, the fourth non-inflation portion 112Sp, and the fifth non-inflation portion 112Tp are all closed regions surrounded by the sewn portion 112 in the bag body 110. The first non-inflation portion 112A, the second non-inflation portion 112B, the third non-inflation portion 112C, the fourth non-inflation portion 112Sp, and the fifth non-inflation portion 112Tp do not inflate even when the inflation gas IG is supplied to the bag body 110.

The first non-inflation portion 112A is arranged between the inner tube 120 and the second non-inflation portion 112B in the upper-lower direction UD/DD (see the upper central portion in FIG. 5). The first non-inflation portion 112A is arranged between the first inflation chamber opening 121 and the second inflation chamber opening 122 of the inner tube 120 in the front-rear direction FD/BD.

The second non-inflation portion 112B is arranged between the first part SC11 and the second part SC12 of the first sub chamber SC1 in the upper-lower direction UD/DD (see the middle central portion in FIG. 5). The second non-inflation portion 112B partitions the first part SC11 and the second part SC12 of the first sub chamber SC1. The second non-inflation portion 112B is arranged between the third part SC13 of the first sub chamber SC1 and the first inflation chamber MC1 in the front-rear direction FD/BD.

The third non-inflation portion 112C is arranged between the inner tube 120 and the second non-inflation portion 112B in the upper-lower direction UD/DD (see the upper central portion in FIG. 5). The third non-inflation portion 112C is arranged in the rearward direction BD of the first non-inflation portion 112A in the front-rear direction FD/BD. The third non-inflation portion 112C is arranged between the first inflation chamber opening 121 and the first sub chamber opening 126 of the inner tube 120 in the front-rear direction FD/BD.

The fourth non-inflation portion 112Sp is connected to a rear end of the partition portion 112S that partitions the second inflation chamber MC2 and the second sub chamber SC2 (see the middle central portion in FIG. 5). The fifth non-inflation portion 112Tp is connected to a front end of the partition portion 112T that partitions the third inflation chamber MC3 and the first sub chamber SC1 (see the upper central portion in FIG. 5).

The first orifice MO11 is defined by the first non-inflation portion 112A and the third non-inflation portion 112C (see the upper central portion in FIG. 5). The inflation gas IG flowing into the first inflation chamber MC1 flows through the first orifice MO11 (see the arrow Fm1 in FIG. 4). The first inflation chamber opening 121 of the inner tube 120 is arranged in a position facing the first orifice MO11.

Part of the inflation gas IG introduced from the connection opening 129 flows through the first orifice MO11 passing through the inner tube 120 (see the arrow Fm1 in FIG. 4). Other part of the inflation gas IG introduced from the connection opening 129 once flows into the second inflation chamber MC2 passing through the inner tube 120 (see the arrow Fm2 in FIG. 4). Thereafter, part of the inflation gas IG flows out of the second inflation chamber MC2 and flows through the first orifice MO11 passing through or not passing through the inner tube 120 (see the arrow Fm1 in FIG. 4).

The second orifice SO11 is defined by the third non-inflation portion 112C and the fifth non-inflation portion 112Tp (see the upper central portion in FIG. 5). The inflation gas IG flowing into the first sub chamber SC1 flows through the second orifice SO11 (see the arrow Fs1 in FIG. 4). The first sub chamber opening 126 of the inner tube 120 is arranged in a position facing the second orifice SO11.

Part of the inflation gas IG introduced from the connection opening 129 flows through the second orifice SO11 passing through the inner tube 120 (see the arrow Fs1 in FIG. 4). Other part of the inflation gas IG introduced from the connection opening 129 once flows into the third inflation chamber MC3 passing through the inner tube 120 (see the arrow Fm3 in FIG. 4). Thereafter, part of the inflation gas IG flows out of the third inflation chamber MC3, and flows through the second orifice SO11 passing through or not passing through the inner tube 120 (see the arrow Fs1 in FIG. 4).

With such a configuration, following effects may be obtained by adjusting magnitudes of the first inflation chamber opening 121 and the first sub chamber opening 126 of the inner tube 120 and shapes of the first orifice MO11, the second orifice SO11, and the first sub chamber SC1. That is, the amount of inflation gas IG flowing into the first inflation chamber MC1 and the amount of inflation gas IG flowing into the first sub chamber SC1 along with passage of time from the start of supply of the inflation gas IG may be appropriately adjusted. As a result, it is possible to appropriately control the inflation way of the first inflation chamber MC1 along with passage of time from the start of supply of the inflation gas IG.

As described above, the length Ls1 of the first sub chamber SC1 along the flow direction Ds1 of the inflation gas IG is larger than the width Ws11 of the second orifice SO11 (see the upper central portion and a right portion in FIG. 5). In this specification, a “width of an orifice” is the width of a narrowest part of a flow passage of the orifice. In the drawings of the present application, to facilitate technique understanding, a width of each orifice is indicated by a double-headed arrow drawn on a paper surface regardless of three-dimensional positions of two points on an inner wall of the orifice that face the narrowest part of the flow passage of the orifice.

The first inflation chamber orifice MO12 is defined by the first non-inflation portion 112A and the second non-inflation portion 112B (see the middle central portion in FIG. 5). The first inflation chamber orifice MO12 is located on a side opposite to the connection opening 129 of the inner tube 120 relative to the first orifice MO11. The inflation gas IG flowing into the first inflation chamber MC1 flows through the first inflation chamber orifice MO12 (see the arrow Fm1 in FIG. 4). The inflation gas IG flowing into the inner tube 120 and the bag body 110 from the connection opening 129 flows into the first inflation chamber MC1 passing through the first orifice MO11 and then passing through the first inflation chamber orifice MO12.

A width Wm11 of the first orifice MO11 is smaller than a width Wm12 of the first inflation chamber orifice MO12 (see the upper central portion in FIG. 5). For this reason, at an early stage after the start of supply of the inflation gas IG, the shape and the magnitude of the first orifice MO11 are more dominant over an inflow amount of gas into the first inflation chamber MC1 than the shape and the magnitude of the first inflation chamber orifice MO12 are.

The second inflation chamber orifice MO2 is defined by the outer edge sewn portion 1120 and the first non-inflation portion 112A (see the upper central portion in FIG. 4). The second inflation chamber orifice MO2 is located in the forward direction FD of the first orifice MO11 and the second orifice SO11. The inflation gas IG flowing into the second inflation chamber MC2 flows through the second inflation chamber orifice MO2. The inflation gas IG flowing out of the second inflation chamber MC2 also flows through the second inflation chamber orifice MO2. The inflation gas IG passing through the second inflation chamber orifice MO2 includes the inflation gas IG passing inside the inner tube 120 and the inflation gas IG passing outside the inner tube 120.

The third inflation chamber orifice MO3 is defined by the outer edge sewn portion 1120 and the fifth non-inflation portion 112Tp (see the upper central portion in FIG. 4). The third inflation chamber orifice MO3 is located in the rearward direction BD of the first orifice MO11 and the second orifice SO11. The inflation gas IG flowing into the third inflation chamber MC3 flows through the third inflation chamber orifice MO3. The inflation gas IG flowing out of the third inflation chamber MC3 also flows through the third inflation chamber orifice MO3. The inflation gas IG passing through the third inflation chamber orifice MO3 includes the inflation gas IG passing inside the inner tube 120 and the inflation gas IG passing outside the inner tube 120.

A tubular part of the inner tube 120 in which the connection opening 129 is provided inclines in the downward direction DD so that the inflation gas IG flows forward. In the bag body 110, a width of the third inflation chamber orifice MO3 is smaller than a width of the second inflation chamber orifice MO2. As a result, a larger amount of inflation gas IG flows into the second inflation chamber MC2 than into the third inflation chamber MC3 at an early stage after the start of supply of the inflation gas IG.

The communication orifice CO1 allows communication between the first inflation chamber MC1 and the second inflation chamber MC2 (see a middle central portion in FIG. 4). The communication orifice CO1 is located in the rearward direction BD of the second sub chamber SC2. The inflation gas IG flowing from the second inflation chamber MC2 to the first inflation chamber MC1 flows through the communication orifice CO1.

The first sub chamber orifice SO12 is defined by the fifth non-inflation portion 112Tp and the second non-inflation portion 112B (see the upper central portion in FIG. 5). The first sub chamber orifice SO12 is on a side opposite to the connection opening 129 of the inner tube 120 relative to the second orifice SO11. The inflation gas IG flowing into the first sub chamber SC1 flows through the first sub chamber orifice SO12 (see the arrow Fs1 in FIG. 4). The inflation gas IG flowing into the inner tube 120 and the bag body 110 from the connection opening 129 flows into the first sub chamber SC1 passing through the second orifice SO11 and then passing through the first sub chamber orifice SO12.

The width Ws11 of the second orifice SO11 is smaller than the width Ws12 of the first sub chamber orifice SO12 (see the upper central portion in FIG. 5). For this reason, at an early stage after the start of supply of the inflation gas IG, the shape and the magnitude of the second orifice SO11 are more dominant over the inflow amount of gas into the first sub chamber SC1 than the shape and the magnitude of the first sub chamber orifice SO12 are.

The second sub chamber orifice SO2 is defined by the outer edge sewn portion 1120 and the fourth non-inflation portion 112Sp (see the lower central portion in FIG. 4). The inflation gas IG flowing into the second sub chamber SC2 flows through the second sub chamber orifice SO2 (see the arrow Fs2 in FIG. 4). The second sub chamber orifice SO2 is arranged on a side opposite to the first orifice MO11 relative to the communication orifice CO1. That is, in a plan view of the bag body 110, when a straight line that is perpendicular to a line segment defining a narrowest part of a width of a flow passage of the communication orifice CO1 at a midpoint of the line segment is defined, the second sub chamber orifice SO2 is on one side of the straight line, and the first orifice MO11 is on the other side.

The bag body 110 has the communication orifice CO1, the second sub chamber SC2, and the second sub chamber orifice SO2 respectively having the above-described configurations. For this reason, it is possible to more appropriately control the inflation ways of at least the first inflation chamber MC1 and the second inflation chamber MC2 by adjusting the magnitude and the arrangement of the communication orifice CO1, the magnitude and the arrangement of the second sub chamber SC2, and the magnitude and the arrangement of the second sub chamber orifice SO2.

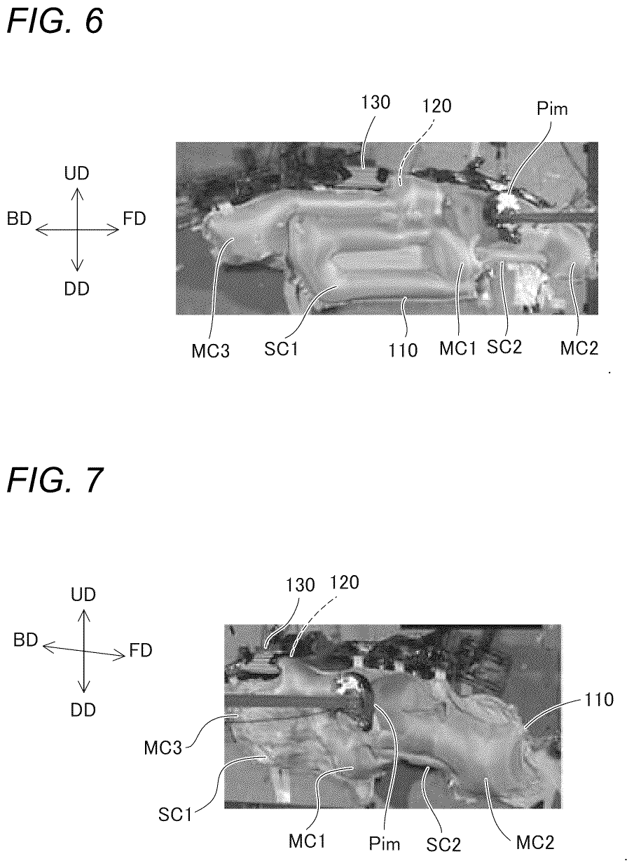

FIG. 6 is a photograph illustrating a state in which the bag body 110 completes inflation and deployment. FIG. 7 is a photograph illustrating a state in which the bag body 110 starts inflation and deployment but before completing inflation and deployment. Unlike the curtain airbag device 100 illustrated in FIGS. 1 to 5, a curtain airbag device illustrated in FIGS. 6 and 7 is deployed along the left side wall of the vehicle MV. To facilitate technique understanding, the curtain airbag device illustrated in FIGS. 6 and 7 is also referred to as the curtain airbag device 100.

FIGS. 6 and 7 illustrate the first inflation chamber MC1, the second inflation chamber MC2, the third inflation chamber MC3, the first sub chamber SC1, and the second sub chamber SC2. FIGS. 6 and 7 illustrate a probe Pim for impactor evaluation. With the probe Pim, a distance from a reference position in the vehicle MV, deployment time, a maximum load, an energy absorption amount, and the like are measured for each impact point IP of the bag body 110 (see IP in FIG. 1).

As can be seen from FIG. 7, the first inflation chamber MC1, the second inflation chamber MC2, and the third inflation chamber MC3 inflate at an earlier stage than the first sub chamber SC1 and the second sub chamber SC2 do. After the state illustrated in FIG. 7, the excess inflation gas IG supplied to the first inflation chamber MC1, the second inflation chamber MC2, and the third inflation chamber MC3 moves to the first sub chamber SC1 and the second sub chamber SC2 through respective orifices. As a result, the amount of inflation gas IG flowing into the first inflation chamber MC1, the amount of inflation gas IG flowing into the second inflation chamber MC2, and the amount of inflation gas IG flowing into the third inflation chamber MC3 along with passage of time from the start of supply of the inflation gas IG are adjusted. As a result of the adjustment, the distance from the reference position in the vehicle MV, the deployment time, the maximum load, the energy absorption amount, and the like in the curtain airbag device 100 according to the present embodiment are appropriate values for each impact point IP of the bag body 110.

As described above, following effects may be obtained in the present embodiment by adjusting at least the magnitude of the first inflation chamber opening 121 of the inner tube 120 and the shapes of the first orifice MO11, the second orifice SO11, and the first sub chamber SC1 (see the middle central portion in FIG. 4). That is, the amount of inflation gas IG flowing into the first inflation chamber MC1 and the amount of inflation gas IG flowing into the first sub chamber SC1 along with passage of time from the start of supply of the inflation gas IG may be adjusted. As a result, it is possible to appropriately control the inflation way of the first inflation chamber MC1 along with passage of time from the start of supply of the inflation gas IG.

The vehicle MV according to the present embodiment is also referred to as a “moving body”. The second inflation chamber MC2 of the bag body 110 is also referred to as a “main chamber” or a “front main chamber”. The third inflation chamber MC3 of the bag body 110 is also referred to as a “main chamber” or a “rear main chamber”. The sewn portion 112 of the bag body 110 is also referred to as a “joint portion”.

### B. Second Embodiment

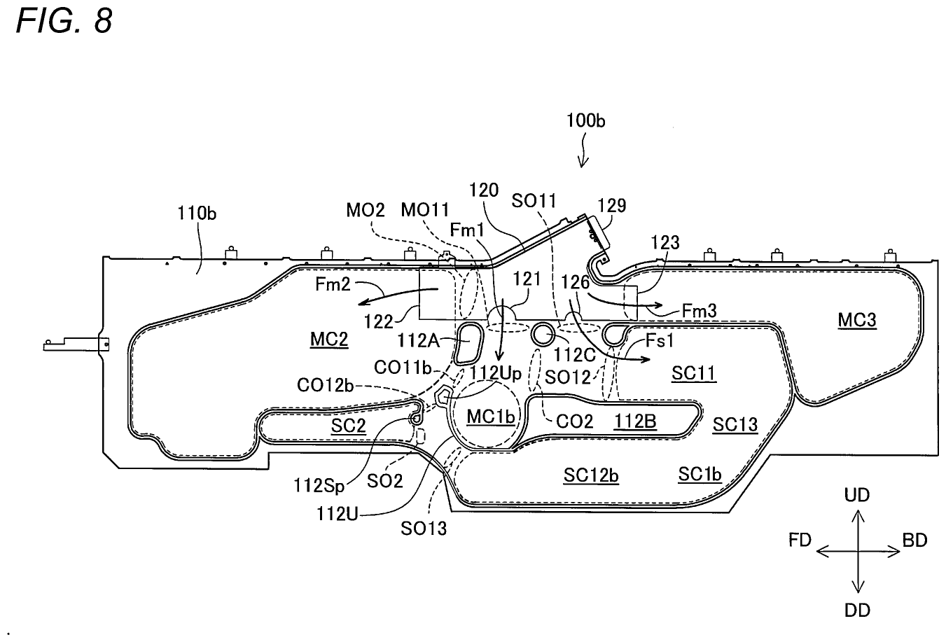

FIG. 8 is a schematic view illustrating configurations of a curtain airbag device 100b according to a second embodiment. Among the configurations of the curtain airbag device 100b according to the second embodiment, the same configurations as those of the curtain airbag device 100 according to the first embodiment are denoted by the same reference signs as those of the configurations of the curtain airbag device 100. The configurations of the curtain airbag device 100b are not the same as the configurations of the curtain airbag device 100. Configurations that correspond to configurations of the curtain airbag device 100 and have similar functions are assigned reference signs according to following rules. That is, reference signs obtained by assigning “b” to ends of reference signs assigned to the configurations of the curtain airbag device 100 are assigned to such configurations (see FIGS. 1 and 8).

A bag body 110b of the curtain airbag device 100b includes a sixth non-inflation portion 112Up, a communication orifice CO11b, a communication orifice CO12b, and a partition portion 112U in place of the communication orifice CO1 (see a lower central portion in FIG. 8). The curtain airbag device 100b further includes a first sub chamber orifice SO13. The other aspects of the curtain airbag device 100b are the same as those of the curtain airbag device 100.

The curtain airbag device 100b includes the sixth non-inflation portion 112Up, the communication orifice CO11b, and the communication orifice CO12b in positions corresponding to the communication orifice CO1 of the curtain airbag device 100. The communication orifice CO12b, the sixth non-inflation portion 112Up, and the communication orifice CO11b are arranged in this order from the fourth non-inflation portion 112Sp toward the first non-inflation portion 112A between the fourth non-inflation portion 112Sp and the first non-inflation portion 112A.

The communication orifice CO11b allows communication between a first inflation chamber MC1b and the second inflation chamber MC2 (see a middle central portion in FIG. 8). The communication orifice CO12b allows communication between the second inflation chamber MC2, the second sub chamber SC2 and a first sub chamber SC1b (see the middle central portion in FIG. 8).

The sixth non-inflation portion 112Up is connected to the second non-inflation portion 112B by the partition portion 112U that is a portion of the sewn portion 112 (see the lower central portion in FIG. 8). The partition portion 112U defines a portion of an outer edge of the first inflation chamber MC1b.

The first sub chamber SC1b of the curtain airbag device 100b includes the first part SC11, the second part SC12, and a third part SC13b (see a lower right portion in FIG. 8). Inside of the second part SC12b of the first sub chamber SC1b communicates with outside of the second part SC12b through the first sub chamber orifice SO13 (see the lower central portion in FIG. 8).

Also in the curtain airbag device 100b according to the second embodiment, by adjusting at least a magnitude of the first inflation chamber opening 121 of the inner tube 120 and shapes of the first orifice MO11, the second orifice SO11, and the first sub chamber SC1b, it is possible to appropriately control an inflation way of the first inflation chamber MC1 along with passage of time from a start of supply of the inflation gas IG.

### C. Third Embodiment

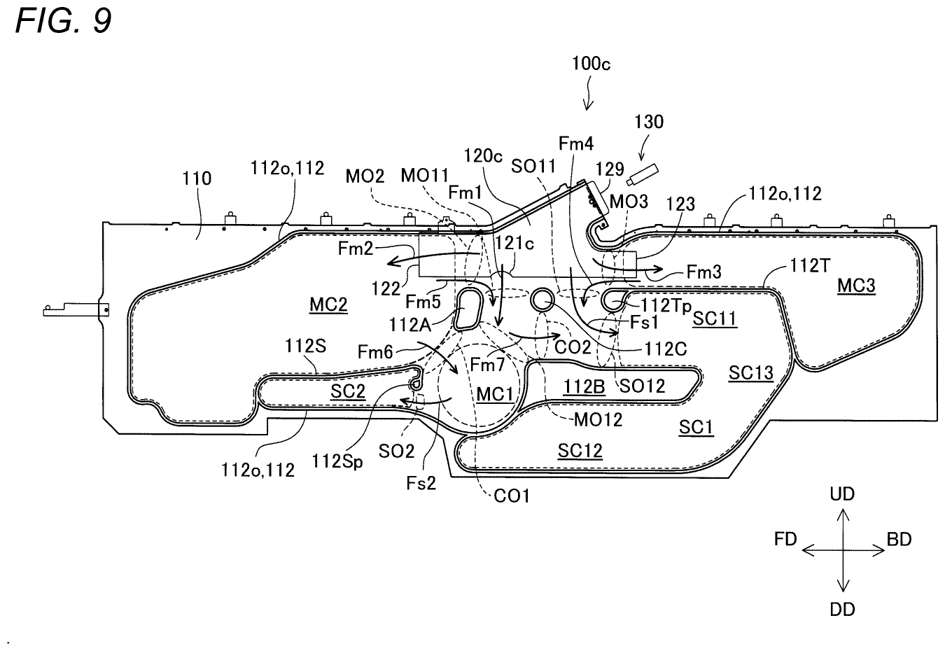

FIG. 9 is a schematic view illustrating configurations of a curtain airbag device 100c according to a third embodiment. Among the configurations of the curtain airbag device 100c according to the third embodiment, the same configurations as those of the curtain airbag device 100 according to the first embodiment are denoted by the same reference signs as those of the configurations of the curtain airbag device 100. The configurations of the curtain airbag device 100c are not the same as the configurations of the curtain airbag device 100. Configurations that correspond to configurations of the curtain airbag device 100 and have similar functions are assigned reference signs according to following rules. That is, reference signs obtained by assigning “c” to ends of reference signs assigned to the configurations of the curtain airbag device 100 are assigned to such configurations (see FIGS. 1 and 9).

The curtain airbag device 100c includes an inner tube 120c instead of the inner tube 120. The other aspects of the curtain airbag device 100c are the same as those of the curtain airbag device 100.

The inner tube 120c does not have the first sub chamber opening 126 (see FIG. 3). The inner tube 120c has a smaller magnitude in the upper-lower direction UD/DD than the inner tube 120 (see an upper central portion in FIG. 9). As a result, the inflation gas IG may circulate more easily from the second inflation chamber MC2 toward the third inflation chamber MC3 and from the third inflation chamber MC3 to the second inflation chamber MC2 below the inner tube 120c in the bag body 110.

In such a mode, the amount of inflation gas IG once flowing into and then out of the third inflation chamber MC3 and flowing through the second orifice SO11 without passing through the inner tube 120c is larger than that in the first embodiment (see the arrows Fm3 and Fm4 in FIG. 9). Similarly, the amount of inflation gas IG once flowing into then out of the second inflation chamber MC2 and flowing through the first orifice MO11 without passing through the inner tube 120c is larger than that in the first embodiment (see arrows Fm2 and Fm5 in FIG. 9). To facilitate technique understanding, in FIG. 9, a flow of the inflation gas IG flowing into the first inflation chamber MC1 from the second inflation chamber MC2 is indicated by an arrow Fm6. A flow of the inflation gas IG flowing in the connection chamber CC toward the first sub chamber SC1 is indicated by an arrow Fm7. An outflow of the inflation gas IG from the third inflation chamber MC3 and the second inflation chamber MC2 is also generated in the curtain airbag device 100 according to the first embodiment and the curtain airbag device 100b according to the second embodiment.

Also in the curtain airbag device 100c according to the third embodiment, following effects may be obtained by adjusting magnitudes of the first inflation chamber opening 121 of the inner tube 120c and shapes of the first orifice MO11, the second orifice SO11, and the first sub chamber SC1. That is, the amount of inflation gas IG flowing into the first inflation chamber MC1 and the amount of inflation gas IG flowing into the first sub chamber SC1 along with passage of time from a start of supply of the inflation gas IG may be adjusted. As a result, it is possible to appropriately control the inflation way of the first inflation chamber MC1 along with passage of time from the start of supply of the inflation gas IG.

### D. Other Embodiments

### D1. Another Embodiment 1-1

(1) In the above-described embodiment, the bag body 110 is constituted by two pieces of substantially rectangular cloth made of polyethylene terephthalate and stacked and sewn together (see FIG. 1). Alternatively, a bag body may be made of another material as long as it is a flexible sheet-shaped material. The bag body may be manufactured by a method other than sewing, such as bonding or welding. The bag body may be manufactured by a plurality of methods such as a combination of bonding and sewing.

(2) In the above-described embodiment, the inner tube 120 is constituted by two pieces of cloth made of polyethylene terephthalate and stacked and sewn together (see FIGS. 1 and 3). Alternatively, an inner tube may be made of another material as long as it is a flexible sheet-like material. The inner tube may be made of the same material as the bag body, or may be made of a material different from that of the bag body. The inner tube may be manufactured by a method other than sewing, such as bonding or welding. The inner tube may be manufactured by a plurality of methods such as a combination of bonding and sewing.

(3) In the above-described embodiment, the distal end portion of the bifurcating tube of the inner tube 120 is arranged outside the bag body 110 (see the upper central portion in FIG. 1). Alternatively, a whole inner tube may be arranged in the bag body 110.

(4) In the above-described embodiment, the first sub chamber SC1 is described to adjust the inflation way of the first inflation chamber MC1 (see the lower central portion in FIG. 4). Alternatively, a first sub chamber may have a function of adjusting an inflation way of another inflation chamber.

(5) In the above-described embodiment, the first inflation chamber MC1 is described to alleviate the impact on the protection objects PO1 and PO2 in the vehicle MV by being inflated by the inflation gas IG (see the lower central portion in FIG. 4). Alternatively, a first inflation chamber may have a function of adjusting an inflation way of another inflation chamber.

(6) In the above-described embodiment, the inflation chambers MC2 and MC3 that deploy beside seats of the vehicle MV have outer edges defined by the sewn portion 112, and each have one or two orifices as locations in which inside communicates with outside (see FIG. 4). In an inflation chamber that deploys beside a seat, a length ratio of a part of an outer periphery of the inflation chamber that opens as an orifice is preferably 20 to 35%, and more preferably 22 to 25%. In such a configuration, by adjusting a shape of the orifice of the inflation chamber, it is easy to adjust the inflation way of the inflation chamber along with passage of time from a start of supply of inflation gas.

(7) In the above-described embodiment, the sub chambers SC1 and SC2 have outer edges defined by the sewn portion 112, and each have one orifice as a location in which inside communicates with outside (see FIG. 4). In a sub chamber, a length ratio of a part of an outer periphery of the sub chamber that opens as an orifice is preferably 8 to 25%, and more preferably 10 to 20%. In such a configuration, by adjusting a shape of the orifice of the sub chamber, it is easier to adjust the inflation way of the inflation chamber along with passage of time from the start of supply of the inflation gas.

(8) In the above-described embodiment, the support pillar MVp2 of the vehicle MV supports the roof MVr of the vehicle MV and the rear seat door MVd2 of the vehicle MV (see the lower central portion in FIG. 1). Alternatively, a support pillar of a moving body may support only a roof or only a door. For example, a support pillar in a center of a four-door double door vehicle supports a roof without supporting a door. A support pillar at a front portion of a convertible supports a door without supporting a roof.

(9) In the above-described embodiment, the technique of the present disclosure is described taking a curtain airbag device for the vehicle MV as an example. Alternatively, the curtain airbag device may also be applied to other moving bodies such as ships, flying machines, and space ships.

### D2. Another Embodiment 1-2

In the first embodiment, the inner tube 120 has the first sub chamber opening 126 (see FIG. 3). Alternatively, as illustrated in the third embodiment, an inner tube may not have a first sub chamber opening (see the upper central portion in FIG. 9).

### D3. Another Embodiment 1-3

In the above-described embodiment, the bag body 110 includes the second inflation chamber MC2 and the third inflation chamber MC3 (see FIG. 4). Alternatively, a bag body may not include one or more of these configurations. In the above-described embodiment, the inner tube 120 includes the second inflation chamber opening 122 and the third inflation chamber opening 123. Alternatively, an inner tube may not include one or more of these configurations.

### D4. Another Embodiment 1-4

In the first embodiment, the bag body 110 includes the second sub chamber SC2, the connection chamber CC, the first inflation chamber orifice MO12, the communication orifices CO1 and CO2, the first sub chamber orifice SO12, and the second sub chamber orifice SO2 (see FIG. 4). Alternatively, a bag body may not include one or more of these configurations. For example, the second non-inflation portion 112B and the third non-inflation portion 112C may be integrated.

### D5. Another Embodiment 1-5

In the above-described embodiment, the first inflation chamber MC1 is located closer to the support pillar MVp2 of the vehicle MV than the second inflation chamber MC2 and the third inflation chamber MC3 are in the front-rear direction FD/BD of the vehicle MV (see the lower central portion in FIG. 4). Alternatively, the first inflation chamber MC1 may be arranged in a position farther from the support pillar MVp2 of the vehicle MV than the second inflation chamber MC2 or the third inflation chamber MC3 are in the front-rear direction FD/BD of the vehicle MV.

### D6. Another Embodiment 1-6

In the above-described embodiment, the length Ls1 of the first sub chamber SC1 along the flow direction Ds1 of the inflation gas IG is larger than the width Ws11 of the second orifice SO11 (see the middle right portion and the upper central portion in FIG. 5). In the above-described embodiment, the length Ls2 of the second sub chamber SC2 along the flow direction Ds2 of the inflation gas IG is larger than the width Ws2 of the second sub chamber orifice SO2 (see the lower left portion in FIG. 5). Alternatively, a sub chamber may be configured such that a length of the sub chamber is smaller than a width of a sub chamber orifice.

### D7. Another Embodiment 1-7

In the above-described embodiment, the first sub chamber SC1 includes the first part SC11, the second part SC12, and the third part SC13 (see the lower right portion in FIG. 4). The first part SC11 is a part of the first sub chamber SC1 that extends rearward from a position downward of the inner tube 120. The second part SC12 is a part of the first sub chamber SC1 that extends rearward from a position downward of the inner tube 120. The third part SC13 is a part of the first sub chamber SC1 that connects the rear end of the first part SC11 and the rear end of the second part SC12. Alternatively, the first sub chamber SC1 may be substantially linear, which is similar to the second sub chamber SC2.

### E. Fourth Embodiment

### E-1. Configuration of Device

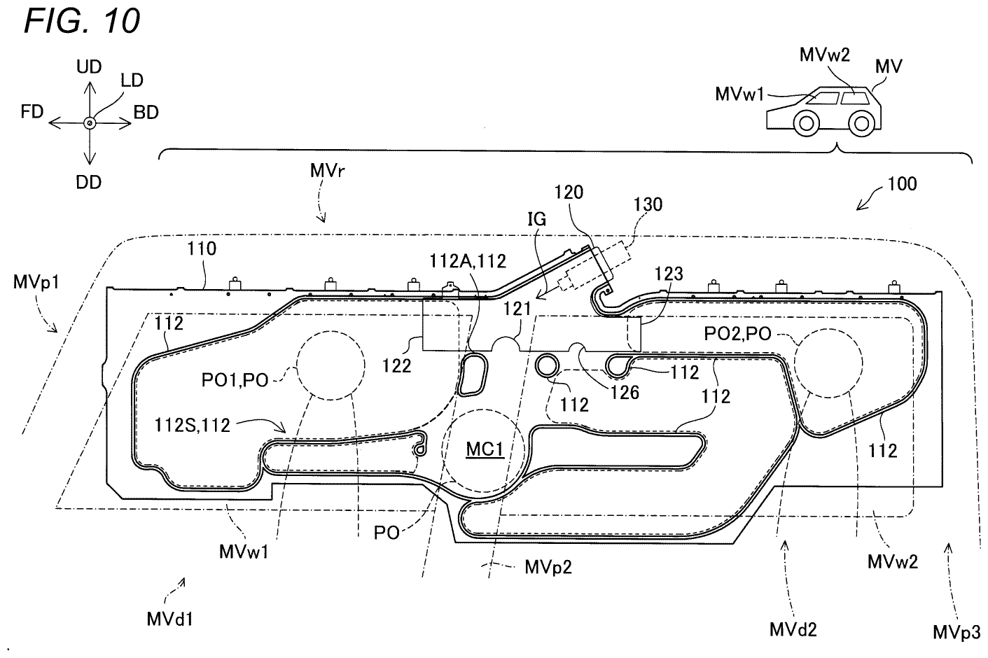

FIG. 10 is a schematic view illustrating the curtain airbag device 100 in the vehicle MV. The curtain airbag device 100 according to the present embodiment is mounted on the vehicle MV and protects a protection object PO when a collision occurs or is predicted for the vehicle MV. FIG. 10 illustrates the curtain airbag device 100 when a side wall portion of the vehicle MV is viewed from inside the vehicle.

In the drawings and the following description, the forward direction FD indicates a frontward direction in a traveling direction of the vehicle MV, and the rearward direction BD indicates a rearward direction in the traveling direction of the vehicle MV. Further, the upward direction UD indicates an upward direction in a height direction of the vehicle MV, and the downward direction DD indicates a downward direction in the height direction of the vehicle MV. In the present specification, one side of an object may be indicated based on the directions of the drawings. For example, when indicating a position in the forward direction FD, it is described as a “front side”. Additionally, a direction along the forward direction FD and the rearward direction BD is referred to as a front-rear direction. A direction along the upward direction UD and the downward direction DD is referred to as an upper-lower direction. A direction perpendicular to the front-rear direction and the upper-lower direction is referred to as a left-right direction. In FIG. 10, only a left direction LD parallel to the left-right direction is illustrated.

The vehicle MV has two rows of seats. The vehicle MV has a first row on the front side and a second row on a rear side. Further, the vehicle MV is provided with an A-pillar MVp1, a B-pillar MVp2, and a C-pillar MVp3 in the side wall portion in the left-right direction. Additionally, the vehicle MV is provided with a front door MVd1 including a side window MVw1 on the front side, between the A-pillar MVp1 and the B-pillar MVp2. The vehicle MV is provided with a rear door MVd2 including a side window MVw2 on the rear side, between the B-pillar MVp2 and the C-pillar MVp3. In this specification, a range of various pillars also includes covers that cover structural parts of the vehicle MV.

The protection object PO according to the present embodiment includes the protection object PO1 as an occupant in the first row of the vehicle MV and the protection object PO2 as an occupant in the second row of the vehicle MV. As illustrated in FIG. 10, the protection object PO is indicated by a broken line.

The curtain airbag device 100 includes the inflator 130, the inner tube 120, the bag body 110, and an accommodation portion (not illustrated). In the curtain airbag device 100, the bag body 110, the inner tube 120, and the inflator 130 are accommodated in a roof side MVr part on an upper side of the side wall portion of the vehicle MV as the accommodation portion. The bag body 110 and the inner tube 120 are accommodated in the accommodation portion in a folded state. When protecting the protection object PO, the curtain airbag device 100 deploys the bag body 110, the inner tube 120, and the like in the downward direction DD from the accommodation portion. Specifically, as illustrated in FIG. 10, the accommodation portion is provided in a portion from a part of the A-pillar MVp1 to a part of the C-pillar MVp3 of the vehicle MV above the side window MVw1 on the front side and the side window MVw2 on the rear side.

The inflator 130 injects the inflation gas IG into the bag body 110. More specifically, when a control unit (not illustrated) mounted on the vehicle MV detects or predicts occurrence of a collision, the control unit instructs the inflator 130 to inject the inflation gas IG. The inflator 130 is arranged at an upper opening of the curtain airbag device 100 illustrated in FIG. 10. The inflator 130 is inserted into the inner tube 120 described later.

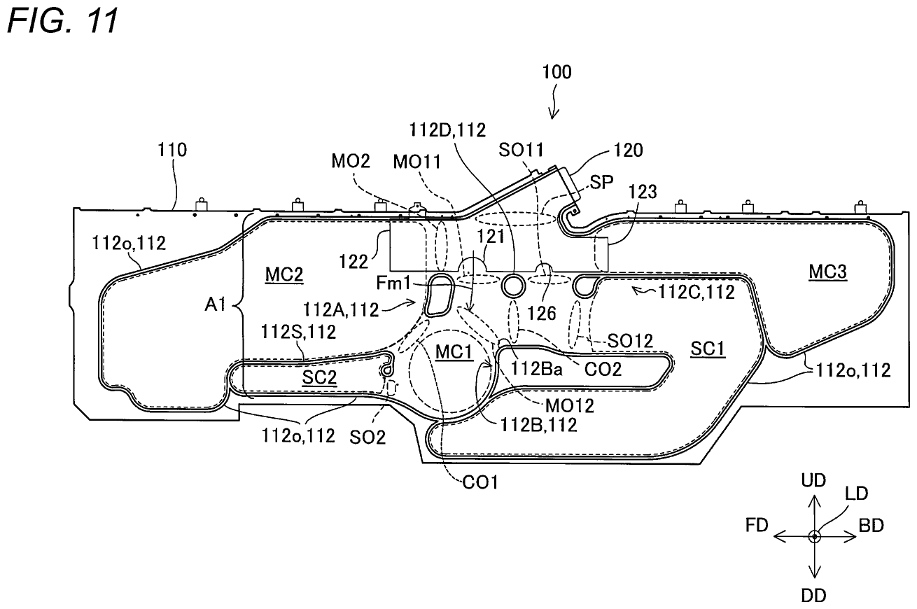

FIG. 11 is a schematic view illustrating the bag body 110. The inner tube 120 regulates the flow of the inflation gas IG and causes the inflation gas IG to flow into the bag body 110. The inner tube 120 is arranged inside the bag body 110. A part of the inflator 130 is inserted into the inner tube 120, and the inner tube 120 receives the inflation gas IG inside. The inner tube 120 includes a plurality of openings that communicate with various openings and various orifices of the bag body 110. More specifically, the inner tube 120 includes a central main chamber opening 121, a rear sub chamber opening 126, a front main chamber opening 122, and a rear main chamber opening 123.

The central main chamber opening 121 is arranged in a position facing a first central orifice MO11 and discharges the inflation gas IG. The rear sub chamber opening 126 is arranged at a position facing a second central orifice SO11 and discharges the inflation gas IG. The various orifices will be will be described later.

The front main chamber opening 122 discharges the inflation gas IG to a front main chamber MC2. That is, the front main chamber opening 122 is inserted into a second front main chamber orifice MO2. Therefore, a width of the front main chamber opening 122 is set based on a width Wc2 of the second front main chamber orifice MO2. The front main chamber MC2 and the second front main chamber orifice MO2 will be described later.

The rear main chamber opening 123 discharges the inflation gas IG to a rear main chamber MC3 described later. That is, the rear main chamber opening 123 is inserted into an opening of the rear main chamber MC3.

When being supplied with the inflation gas IG, the bag body 110 inflates and deploys. The bag body 110 is a bag body made of a woven polyamide fabric, for example. The bag body 110 includes a plurality of non-inflation portions 112, a plurality of main chambers, a plurality of sub chambers, a plurality of orifices, a communication flow path MC1, and a body opening SP.

The body opening SP supplies the inflation gas IG into the bag body 110. In the bag body 110, the body opening SP is an innermost part of the flow path connecting outside and inside of the bag body 110. The body opening SP is defined by two sections of an outer peripheral non-inflation portion 1120 serving as the outer non-inflation portion 112 of the bag body 110. That is, as illustrated in FIG. 11, the body opening SP is a connection part between an insertion part of the inflator 130 in the bag body 110 and the bag body 110. The body opening SP receives the inflation gas IG supplied from the inflator 130 into the bag body 110.

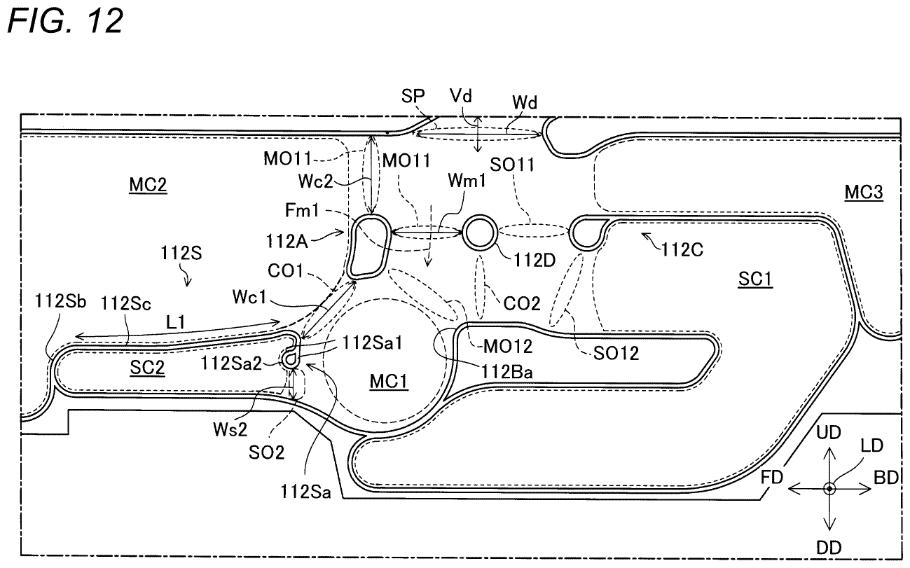

In FIG. 12 described later, a width direction Wd of the body opening SP, which is a direction parallel to a straight line connecting the two sections of the outer peripheral non-inflation portion 1120, and a direction Vd perpendicular to the width direction Wd are illustrated. The width direction Wd of the body opening SP is a direction along the front-rear direction according to the present embodiment, and the direction Vd perpendicular to the width direction Wd is a direction along the upper-lower direction according to the present embodiment.

The plurality of non-inflation portions 112 are portions to which the fabrics constituting the bag body 110 are joined. More specifically, the non-inflation portions 112 are joint parts formed by partially joining two fabrics that constitute the airbag by sewing. That is, the plurality of non-inflation portions 112 do not inflate even when the inflation gas IG is received into the bag body 110. As illustrated in FIG. 11, the plurality of non-inflation portions 112 are not limited to portions along an outer periphery of the bag body 110. The plurality of non-inflation portions 112 include a portion that extends toward inside of the bag body 110 and a portion formed in an island shape in the bag body 110.

In the present embodiment, the plurality of non-inflation portions 112 include the outer peripheral non-inflation portion 1120, a first non-inflation portion 112A, a second non-inflation portion 112B, a third non-inflation portion 112C, a fourth non-inflation portion 112D, and a partition non-inflation portion 112S.

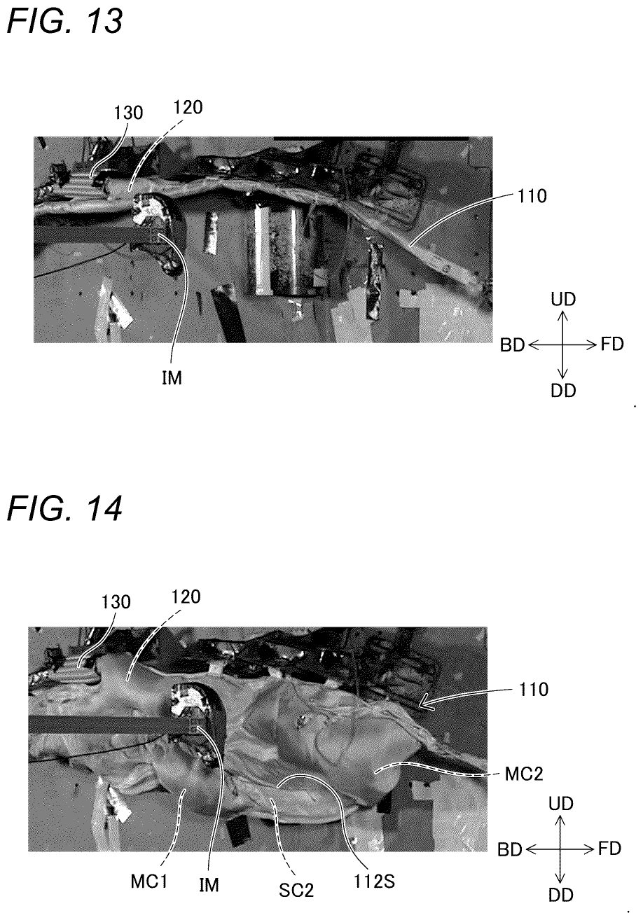

The outer peripheral non-inflation portion 1120 defines an entire shape of the bag body 110 when inflated by receiving the inflation gas IG. As illustrated in FIG. 13, the outer peripheral non-inflation portion 1120 is the non-inflation portion 112 arranged outermost of the bag body 110. That is, the outer peripheral non-inflation portion 1120 is a portion along the outer periphery of the bag body 110.

The partition non-inflation portion 112S partitions the front main chamber MC2 and a front sub chamber SC2. The partition non-inflation portion 112S is illustrated on the front side in FIG. 11. The partition non-inflation portion 112S is a non-inflation portion 112 that extends inward from a lower side of the bag body 110. More specifically, the partition non-inflation portion 112S partitions the front main chamber MC2 and the front sub chamber SC2 by being longer than a width Ws2 of a front sub chamber orifice SO2. The partition non-inflation portion 112S will be described in detail later.

FIG. 12 is an enlarged view of the bag body. The first non-inflation portion 112A partially partitions the communication flow path MC1 serving as the inflation portion and the front main chamber MC2. The first non-inflation portion 112A is illustrated near a center in FIG. 12. The first non-inflation portion 112A is an island-shaped non-inflation portion 112 inside the bag body 110. The first non-inflation portion 112A has a shape in which a magnitude of the body opening SP along the width direction Wd is larger than a magnitude along the direction Vd perpendicular to the width direction Wd. That is, in the present embodiment, the first non-inflation portion 112A has a rectangular shape whose longitudinal direction is along the upper-lower direction. Therefore, a side surface on the front side, among side surfaces of the first non-inflation portion 112A along the longitudinal direction, faces the front main chamber MC2. A side surface on the lower side, among the side surfaces of the first non-inflation portion 112A along the short direction, faces the communication flow path MC1. Various main chambers and various sub chambers will be described in detail later.

The first non-inflation portion 112A partially defines a first front main chamber orifice CO1, a second front main chamber orifice MO2, a central main chamber orifice MO12, and the first central orifice MO11. Definition of various orifices by the first non-inflation portion 112A will be described together with the various orifices.

The second non-inflation portion 112B partially partitions the communication flow path MC1 serving as the inflation portion and a rear sub chamber SC1. The second non-inflation portion 112B is illustrated near a center in FIG. 11. The second non-inflation portion 112B is a non-inflation portion 112 that extends inward from the lower outer peripheral non-inflation portion 1120. Further, the second non-inflation portion 112B partially defines the central main chamber orifice MO12, a rear orifice CO2, and a rear sub chamber orifice SO12.

An end part 112Ba of the second non-inflation portion 112B defines a narrowest part of the central main chamber orifice MO12. As illustrated in FIG. 12, the end part 112Ba of the second non-inflation portion 112B is arranged within a range of the width Wml of the first central orifice MO11 when viewed along a flow path direction Fm1 of the inflation gas IG flowing through the first central orifice MO11. That is, as illustrated in FIG. 11, the end part 112Ba of the second non-inflation portion 112B is arranged between the first non-inflation portion 112A and the fourth non-inflation portion 112D in the front-rear direction.

The third non-inflation portion 112C partitions the rear main chamber MC3 and the rear sub chamber SC1. The third non-inflation portion 112C is illustrated on the rear side in FIG. 11. The third non-inflation portion 112C is a non-inflation portion 112 that extends inward from the rear outer peripheral non-inflation portion 1120. The third non-inflation portion 112C partially defines the second central orifice SO11 and the rear sub chamber orifice SO12.

The fourth non-inflation portion 112D partially defines the first central orifice MO11, the second central orifice SO11, and the rear orifice CO2. The fourth non-inflation portion 112D is illustrated at the center in FIG. 11. The fourth non-inflation portion 112D is an island-shaped non-inflation portion 112 inside the bag body 110. The fourth non-inflation portion 112D is surrounded by the body opening SP, the first non-inflation portion 112A, the second non-inflation portion 112B, and the third non-inflation portion 112C.

Regarding the plurality of main chambers, each main chamber is an inflation portion surrounded by one or more non-inflation portions 112 among the plurality of non-inflation portions 112. The plurality of main chambers includes the front main chamber MC2, a central main chamber MC1, and the rear main chamber MC3. Each main chamber inflates by being supplied with the inflation gas IG, thereby alleviating an impact on the protection object PO resulting from coming into contact with the protection object PO in the vehicle. The “front main chamber” is also referred to as an “inflation chamber”.

The front main chamber MC2 is arranged on the front side of the vehicle MV, and alleviates an impact on the protection object PO1 resulting from coming into contact with the protection object PO1 in the vehicle MV. As illustrated in FIG. 11, the front main chamber MC2 is partitioned by the outermost non-inflation portion 1120, the first non-inflation portion 112A, and the partition non-inflation portion 112S in the bag body 110. The openings in the front main chamber MC2 are the first front main chamber orifice CO1 and the second front main chamber orifice MO2, which will be described later.

The front main chamber MC2 is provided in a predetermined range based on, for example, requirements for evaluation of a new car assignment program (NCAP) or required specifications of a customer. That is, a range of the front main chamber MC2 is determined to ensure a thickness required for various requirements such as requirements for discharge from the vehicle and requirements for evaluation in an impactor test. The thickness of the front main chamber MC2 is a thickness generated by inflation in the left-right direction. In this specification, when referring to the thicknesses of the various main chambers and the thicknesses of the various sub chambers, the thicknesses are the same.

The rear main chamber MC3 is arranged on the rear side of the vehicle MV, and alleviates an impact on the protection object PO2 resulting from coming into contact with the protection object PO2 in the vehicle MV. As illustrated in FIG. 11, the rear main chamber MC3 is defined by the outer peripheral non-inflation portion 1120 and the third non-inflation portion 112C. The opening in the rear main chamber MC3 receives the rear main chamber opening 123. A range of the rear main chamber MC3 is also determined in the same manner as the front main chamber MC2.

As illustrated in FIG. 10, the central main chamber MC1 is arranged at a position of the B-pillar MVp2 in the front-rear direction. The central main chamber MC1 alleviates the impact on the protection object PO, including the protection object PO1 and the protection object PO2, resulting from coming into contact with the protection object PO. As illustrated in FIG. 11, the central main chamber MC1 is partitioned by the outer peripheral non-inflation portion 1120, the second non-inflation portion 112B, the partition non-inflation portion 112S, and the first non-inflation portion 112A. A range of the central main chamber MC1 is also determined in the same manner as the front main chamber MC2.

The communication flow path MC1 allows communication between the front main chamber MC2 and the front sub chamber SC2. In the present embodiment, the central main chamber MC1 functions also as the communication flow path MC1. The communication flow path MC1 is arranged rearward of the front main chamber MC2, and functions as an inflation portion. That is, the communication flow path MC1 serving as the inflation portion alleviates the impact on the protection object PO resulting from coming into contact with the protection object PO.

The plurality of sub chambers include the front sub chamber SC2 and the rear sub chamber SC1. The various sub chambers adjust the inflation way of the front main chamber MC2 in response to receiving the inflation gas IG. The “front sub chamber” is also simply referred to as a “sub chamber”, and the “rear sub chamber” is also referred to as an “additional sub chamber”.

The front sub chamber SC2 adjusts the inflation ways of the front main chamber MC2 and the central main chamber MC1. More specifically, the front sub chamber SC2 receives the inflation gas IG from the front main chamber MC2 and the central main chamber MC1 when a pressure fluctuation occurs in the front main chamber MC2 and the central main chamber MC1 resulting from deployment of the bag body 110 or coming into contact with the protection object PO. That is, the front sub chamber SC2 adjusts pressures of the front main chamber MC2 and the central main chamber MC1. Therefore, when the front sub chamber SC2 functions in response to coming into contact with the protection object PO, the impact on the protection object PO in the front main chamber MC2 and the central main chamber MC1 is alleviated.

The front sub chamber SC2 also alleviates the impact on the protection object PO in the front sub chamber SC2 and prevents the protection object PO from being ejected outside of the vehicle. The front sub chamber SC2 is provided in a predetermined range together with the front main chamber MC2. As described above, the front main chamber MC2 is determined to ensure the thickness required for various requirements. The front sub chamber SC2 is determined to ensure a range required for various requirements. For example, as illustrated in FIG. 11, the front sub chamber SC2 is provided below the front main chamber MC2 between the front main chamber MC2 and the central main chamber MC1 in the front-rear direction to ensure a range A1 required for the requirements of NCAP.

As illustrated in FIG. 11, the front sub chamber SC2 is defined by the outer peripheral non-inflation portion 1120 and the partition non-inflation portion 112S. That is, the front sub chamber SC2 is located below the front main chamber MC2 and is separated from the front main chamber MC2 by the partition non-inflation portion 112S.

The front sub chamber SC2 includes only one opening. The opening of the front sub chamber SC2 is the front sub chamber orifice SO2, which will be described later, and communicates with the communication flow path MC1 that allows communication between the front main chamber MC2 and the front sub chamber SC2. The communication flow path MC1 is also the central main chamber MC1. That is, the front sub chamber SC2 inflates in response to receiving the inflation gas IG from the front main chamber MC2 or the central main chamber MC1.

In response to receiving the inflation gas IG, the rear sub chamber SC1 adjusts inflation ways of the rear main chamber MC3 and the communication flow path MC1 that serves as the inflation portion. More specifically, the rear sub chamber SC1 receives the inflation gas IG from the rear main chamber MC3 or the central main chamber MC1 when a pressure fluctuation occurs in the rear main chamber MC3 and the central main chamber MC1 resulting from the deployment of the bag body 110 or coming into contact with the protection object PO. That is, the rear sub chamber SC1 adjusts pressures of the rear main chamber MC3 and the central main chamber MC1. Therefore, when the rear sub chamber SC1 functions in response to coming into contact with the protection object PO, the impact on the protection object PO in the rear main chamber MC3 and the central main chamber MC1 is alleviated.

The rear sub chamber SC1 also alleviates the impact on the protection object PO2 and prevents the protection object PO2 from being ejected outside of the vehicle. The rear sub chamber SC1 is provided in a predetermined range together with the rear main chamber MC3, similar to the front sub chamber SC2.

The rear sub chamber SC1 is defined by the outer peripheral non-inflation portion 1120, the second non-inflation portion 112B, and the third non-inflation portion 112C. The rear sub chamber SC1 includes only one opening. The opening of the rear sub chamber SC1 is the rear sub chamber orifice SO12 described later. The rear sub chamber SC1 inflates in response to receiving the inflation gas IG from the rear sub chamber opening 126.

The plurality of orifices allow the inflation gas IG received in the various main chambers or various sub chambers to flow therethrough. As illustrated in FIG. 12, the plurality of orifices include the front sub chamber orifice SO2, the first front main chamber orifice CO1, the second front main chamber orifice MO2, the first central orifice MO11, the second central orifice SO11, the central main chamber orifice MO12, the rear orifice CO2, and the rear sub chamber orifice SO12.

The second front main chamber orifice MO2 communicates with the body opening SP among the plurality of orifices. More specifically, the second front main chamber orifice MO2 serves as an opening of the front main chamber MC2 and receives the inflation gas IG supplied from the body opening SP at a position closest to the body opening SP. The “second front main chamber orifice” is also referred to as a “second inflation chamber orifice”.

The second front main chamber orifice MO2 is partially defined by the first non-inflation portion 112A. More specifically, the second front main chamber orifice MO2 has one lower portion defined by the first non-inflation portion 112A, and the other upper portion defined by the outer peripheral non-inflation portion 1120. The width Wc2 of the second front main chamber orifice MO2 represents a width of a narrowest part of the second front main chamber orifice MO2.

The first front main chamber orifice CO1 functions as an opening of the communication flow path MC1 among the plurality of orifices. The first front main chamber orifice CO1 serves as an opening of the front main chamber MC2 and communicates with the communication flow path MC1. That is, the first front main chamber orifice CO1 allows the inflation gas IG to flow between the front main chamber MC2 and the central main chamber MC1. The “first front main chamber orifice” is also referred to as a “first inflation chamber orifice”.

The first front main chamber orifice CO1 further allows the inflation gas IG in the front main chamber MC2 to flow into the front sub chamber SC2 through the communication flow path MC1 when a pressure fluctuation occurs in the front main chamber MC2 resulting from the front main chamber MC2 coming into contact with the protection object PO1.

The first front main chamber orifice CO1 is defined by the partition non-inflation portion 112S and the first non-inflation portion 112A. The first front main chamber orifice CO1 has one lower portion defined by the partition non-inflation portion 112S and the other upper portion defined by the first non-inflation portion 112A. A width of a narrowest part of the first front main chamber orifice CO1 is referred to as a width Wc1 of the first front main chamber orifice CO1.

The front sub chamber orifice SO2 functions as an opening of the front sub chamber SC2. More specifically, the front sub chamber orifice SO2 is provided in the bag body 110 as an opening that connects the front sub chamber SC2 and the central main chamber MC1. Therefore, the front sub chamber orifice SO2 allows the inflation gas IG to flow into the front sub chamber SC2 through the central main chamber MC1. The “front sub chamber orifice” is also simply referred to as a “sub chamber orifice”.

The front sub chamber orifice SO2 is defined by the partition non-inflation portion 112S, which will be described later, and the outer peripheral non-inflation portion 1120. The width Ws2 of the front sub chamber orifice SO2 is a width of a narrowest part of the front sub chamber orifice SO2.

Among the widths of the various orifices, the width Wc1 of the first front main chamber orifice CO1 is larger than the width Ws2 of the front sub chamber orifice SO2. More specifically, a sectional area of a flow passage in the first front main chamber orifice CO1 is larger than a sectional area of a flow passage in the front sub chamber orifice SO2. With such an aspect, the inflation gas IG in the front main chamber MC2 flows out toward the front sub chamber SC2 more easily compared with a case in which the width Wc1 of the first front main chamber orifice CO1 is smaller than the width Wc2 of the front sub chamber orifice SO2. Therefore, the curtain airbag device 100 of the present disclosure may alleviate the impact by easily adjusting a pressure in the front main chamber MC2.

Further, among the widths of the various orifices, the width Wc2 of the second front main chamber orifice MO2 is larger than the width Wc1 of the first front main chamber orifice CO1. More specifically, a sectional area of a flow passage in the second front main chamber orifice MO2 is larger than a sectional area of a flow path in the first front main chamber orifice CO1. With such an aspect, the inflation gas IG is more likely to flow into the front main chamber MC2 from the body opening SP compared with a case in which the width Wc2 of the second front main chamber orifice MO2 is smaller than the width Wc1 of the first front main chamber orifice CO1. Therefore, the front main chamber MC2 may be more easily deployed.

The first central orifice MO11 is arranged in a position facing the body opening SP and discharges the inflation gas IG from the body opening SP toward the central main chamber MC1 and the rear sub chamber SC1. Further, the first central orifice MO11 also functions as a flow path for the inflation gas IG that flows between the central main chamber MC1, the front main chamber MC2, and the like resulting from coming into contact with the protection object PO. The first central orifice MO11 is defined by the first non-inflation portion 112A and the fourth non-inflation portion 112D. The “first central orifice” is also simply referred to as a “central orifice”.

The second central orifice SO11 is arranged in a position facing the body opening SP and discharges the inflation gas IG from the body opening SP toward the rear sub chamber SC1. Furthermore, the first central orifice MO11 also functions as a flow path for the inflation gas IG that flows between the rear main chamber MC3, the rear sub chamber SC1, and the like resulting from coming into contact with the protection object PO. The second central orifice SO11 is defined by the fourth non-inflation portion 112D and the third non-inflation portion 112C.

The rear orifice CO2 discharges the inflation gas IG from the body opening SP rearward. The rear orifice CO2 is arranged between the first central orifice MO11 and the second central orifice SO11 in the front-rear direction. The rear orifice CO2 is defined by the fourth non-inflation portion 112D and the second non-inflation portion 112B. As described above, the end part 112Ba of the second non-inflation portion 112B is arranged between the first non-inflation portion 112A and the fourth non-inflation portion 112D in the front-rear direction. That is, the end part 112Ba of the second non-inflation portion 112B is also between the first non-inflation portion 112A and the third non-inflation portion 112C. A portion of the second non-inflation portion 112B, which defines the rear orifice CO2, partially defines the rear orifice CO2 behind the end part 112Ba of the second non-inflation portion 112B in the front-rear direction.

The central main chamber orifice MO12 is an orifice other than the first front main chamber orifice CO1 and the front sub chamber orifice SO2, as an opening of the communication flow path MC1 that serves as an inflation portion. The central main chamber orifice MO12 is provided to communicate with the body opening SP. The central main chamber orifice MO12 is defined by the first non-inflation portion 112A and the end part 112Ba of the second non-inflation portion 112B. That is, the central main chamber orifice MO12 receives the inflation gas IG supplied from the body opening SP into the central main chamber MC1 through the first central orifice MO11. The “central main chamber orifice” is also referred to as an “another orifice”.

The central main chamber orifice MO12 is also provided to communicate with the rear orifice CO2. For this reason, the central main chamber orifice MO12 also functions as a flow path for the inflation gas IG that flows between the central main chamber MC1 and the rear sub chamber SC1 resulting from coming into contact with the protection object PO.

The rear sub chamber orifice SO12 serves as an opening of the rear sub chamber SC1 and communicates with the rear orifice CO2 and the second central orifice SO11. That is, the rear sub chamber orifice SO12 receives the inflation gas IG supplied from the body opening SP into the rear sub chamber SC1 through the rear orifice CO2 and the second central orifice SO11. Further, the rear sub chamber orifice SO12 also functions as a flow path for the inflation gas IG that flows between the central main chamber MC1 and the rear sub chamber SC1 resulting from coming into contact with the protection object PO.

### E-2. Configuration of Partition Non-Inflation Portion

As described above, the partition non-inflation portion 112S partitions the front main chamber MC2 and the front sub chamber SC2. The partition non-inflation portion 112S includes a front end part 112Sb, a central part 112Sc, and a rear end part 112Sa. As illustrated in FIG. 12, the partition non-inflation portion 112S partitions the front main chamber MC2 and the front sub chamber SC2 by the central part 112Sc extending along the front-rear direction below the front main chamber MC2. In the partition non-inflation portion 112S, the front end 112Sb and the rear end part 112Sa extend from the central part 112Sc toward outside of the bag body 110. The “rear end part” is also simply referred to as an “end part of a partition non-inflation portion”.

The front end part 112Sb is connected to the lower outer peripheral non-inflation portion 1120 of the bag body 110. The front end part 112Sb has a convex shape facing the forward direction FD. That is, the partition non-inflation portion 112S is formed in an arc shape from the lower outer peripheral non-inflation portion 1120 toward the rear side. With such an aspect, since the front end part 112Sb does not have a corner, stress concentration is less likely to occur when a load due to inflation is applied compared with an aspect in which the front end part 112Sb has a corner.

As described above, the central part 112Sc serves as a connection part between the front end part 112Sb and the rear end part 112Sa and extends along the front-rear direction. A length L1 of the central part 112Sc is also a length of the partition non-inflation portion 112S. As described above, the partition non-inflation portion 112S partitions the front main chamber MC2 and the front sub chamber SC2 by being longer than the width Ws2 of the front sub chamber orifice SO2. That is, the length L1 of the central part 112Sc of the partition non-inflation portion 112S is longer than the width Ws2 of the front sub chamber orifice SO2.

With such an aspect, when the bag body 110 is deployed, a force applied to the partition non-inflation portion 112S may be received by the entire partition non-inflation portion 112S, which is longer than the width Ws2 of the front sub chamber orifice SO2. Therefore, stress concentration is less likely to occur in the partition non-inflation portion 112S compared with a mode in which the partition non-inflation portion 112S is shorter than the width Ws2 of the front sub chamber orifice SO2, for example, a mode in which the front main chamber MC2 and the front sub chamber SC2 are partitioned by a plurality of dot-shaped or island-shaped non-inflation portions 112.

The rear end part 112Sa is arranged close to the opening of the front sub chamber SC2 and partially defines the rear sub chamber orifice SO12. The rear end part 112Sa includes a bifurcation section 112Sa1 and an arc-shaped section 112Sa2. The bifurcation section 112Sa1 bifurcates at the rear end part 112Sa. The arc-shaped section 112Sa2 connects distal ends of the bifurcation section 112Sa1 in an arc shape. That is, the rear end part 112Sa has an annular shape.

With such an aspect, stress concentration is less likely to occur in the end part 112Sa of the partition non-inflation portion 112S when a load due to inflation is applied compared with an aspect in which the end part 112Sa of the partition non-inflation portion 112S does not have a closed portion formed by the arc-shaped section 112Sa2 and the bifurcation section 112Sa1.

### E-3. Deployment and Inflation of Bag Body

FIG. 13 is a photograph illustrating a folded state of the curtain airbag device 100. FIG. 13 illustrates a state in which the bag body 110, the inner tube 120, and the inflator 130 are accommodated in the roof side MVr part illustrated in FIG. 10. That is, the bag body 110 and the inner tube 120 are in a folded state. FIG. 13 illustrates an impactor IM used for an impactor test and simulating the protection object PO1.

The bag body 110 illustrated in FIGS. 13 to 16 is in a state of facing opposite to the bag body 110 illustrated in FIGS. 10 to 12. To facilitate technique understanding, components not exposed to the outside are indicated by broken lines.

FIG. 14 is a photograph illustrating mid-deployment of the curtain airbag device 100. When occurrence of a collision is detected or predicted, the curtain airbag device 100 injects the inflation gas IG to the inflator 130. When the bag body 110 and the inner tube 120 start to inflate in response to receiving the inflation gas IG, the bag body 110 and the inner tube 120 are deployed from the folded state. FIG. 14 illustrates a state in which the bag body 110 is partially deployed by supplying the inflation gas IG to a part of the bag body 110.

As illustrated in FIG. 14, the bag body 110 inflates first from various main chambers such as the front main chamber MC2 and the central main chamber MC1. Since the width Ws2 of the rear sub chamber orifice SO12 is designed to be small, the inflation gas IG is less likely to flow into the front sub chamber SC2 until the various main chambers such as the front main chamber MC2 and the central main chamber MC1 reach a certain pressure.

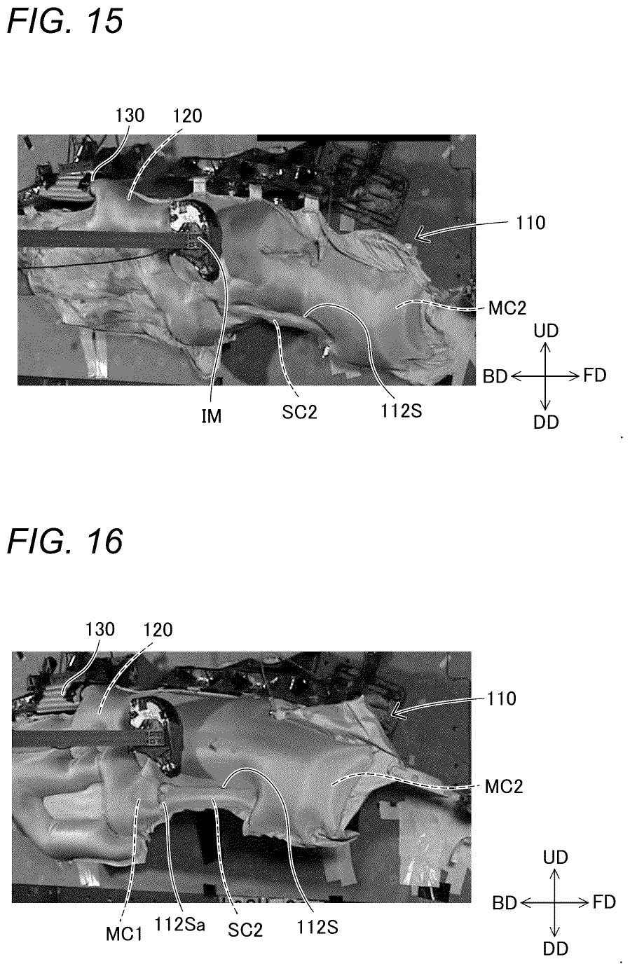

FIG. 15 is a photograph illustrating mid-deployment of the curtain airbag device 100. FIG. 15 illustrates the front sub chamber SC2 in the middle of inflating. When the front main chamber MC2 and the central main chamber MC1 are filled with the inflation gas IG and the pressure is constant, the inflation gas IG is more likely to flow from the front main chamber MC2 and the central main chamber MC1 toward the front sub chamber SC2. Therefore, the front sub chamber SC2 inflates later than the front main chamber MC2 and the central main chamber MC1.

As illustrated in FIG. 15, the front main chamber MC2 is partitioned by the partition non-inflation portion 112S and inflates. Therefore, in the partition non-inflation portion 112S, stress is generated by receiving a load due to inflation of the front main chamber MC2. As described above, the central part 112Sc and the front end part 112Sb of the partition non-inflation portion 112S face the front main chamber MC2. For this reason, specifically, stress is generated in the central part 112Sc and the front end part 112Sb. Stress concentration is less likely to occur in the central part 112Sc because the length L1 of the central part 112Sc is longer than the width Ws2 of the front sub chamber orifice SO2. Stress concentration is also less likely to occur in the front end part 112Sb due to forming in an arc shape.

FIG. 16 is a photograph illustrating a state in which the bag body 110 completes inflation. In the partition non-inflation portion 112S, stress is generated in the rear end part 112Sa facing the central main chamber MC1 by receiving a load due to inflation of the central main chamber MC1. Alternatively, stress concentration is less likely to occur in the end part 112Sa of the partition non-inflation portion 112S compared with an aspect in which the rear end part 112Sa does not have a closed portion formed by the arc-shaped section 112Sa2 and the bifurcation section 112Sa1.

As described above, with such an aspect, when the bag body 110 is deployed, a force applied to the partition non-inflation portion 112S may be received by the entire partition non-inflation portion 112S, which is longer than the width Ws2 of the front sub chamber orifice SO2. Therefore, stress concentration is less likely to occur in the partition non-inflation portion 112S compared with a mode in which the partition non-inflation portion 112S is shorter than the width Ws2 of the front sub chamber orifice SO2, for example, a mode in which the front main chamber MC2 and the front sub chamber SC2 are partitioned by a plurality of dot-shaped or island-shaped non-inflation portions 112.

Further, stress concentration is less likely to occur in the end part 112Sa of the partition non-inflation portion 112S compared with a mode in which the end part 112Sa of the partition non-inflation portion 112S does not have a closed portion formed by the arc-shaped section 112Sa2 and the bifurcation section 112Sa1.

In addition, by providing the front sub chamber SC2 with one opening, an amount of inflation gas IG that can flow into the front sub chamber SC2 is limited by a magnitude of the front sub chamber SC2. That is, an amount of inflation gas IG flowing out of the front main chamber MC2 is also limited. Therefore, the curtain airbag device 100 of the present disclosure may more easily adjust an internal pressure of the front main chamber MC2 by adjusting the magnitude of the front sub chamber SC2. Therefore, the curtain airbag device 100 of the present disclosure may more effectively alleviate the impact on the protection object PO.

Further, since the communication flow path MC1 functions as the inflation portion in this manner, a volume of the communication flow path MC1 is larger than that of a case in which the communication flow path MC1 functions only as a flow path of the inflation gas IG. That is, the flow of the inflation gas IG between the front main chamber MC2 and the front sub chamber SC2 is moderated. Therefore, the curtain airbag device 100 of the present disclosure may alleviate the impact on the protection object PO by moderating a pressure fluctuation of the front main chamber MC2 resulting from coming into contact with the protection object PO.

In addition, in the various orifices provided in the front main chamber MC2, the inflation gas IG in the front main chamber MC2 easily flows out toward the front sub chamber SC2 compared with a case in which the width Wc1 of the first front main chamber orifice CO1 is smaller than the width Ws2 of the front sub chamber orifice SO2. Therefore, the curtain airbag device 100 of the present disclosure may alleviate the impact by easily adjusting the pressure in the front main chamber MC2.

Further, the inflation gas IG is more likely to flow into the front main chamber MC2 from the body opening SP compared with a case in which the width Wc2 of the second front main chamber orifice MO2 is smaller than the width Wc1 of the first front main chamber orifice CO1. Therefore, the front main chamber MC2 may be more easily deployed.

In addition, in the first non-inflation portion 112A, the inflation gas IG discharged from the body opening SP flows in the direction Vd perpendicular to the width direction Wd of the body opening SP. Therefore, since the first non-inflation portion 112A has a large shape in a direction along a flow of the inflation gas IG, a load due to the inflation gas IG may be reduced.

Further, with such an aspect, the inflation gas IG for inflating the front sub chamber SC2 bifurcates and flows into the first front main chamber orifice CO1 serving as the opening of the front main chamber MC2 and into the central main chamber orifice MO12. That is, the pressure in the front main chamber MC2 is reduced by reducing an amount of the inflation gas IG passing through the front main chamber MC2. Therefore, the stress generated in the partition non-inflation portion 112S is reduced by reducing the load applied to the partition non-inflation portion 112S.

Furthermore, with such an aspect, the inflation gas IG flowing through the first central orifice MO11 flows into the communication flow path MC1 serving as the inflation portion and into the rear sub chamber SC1 through the second non-inflation portion 112B. That is, the inflation gas IG is more likely to flow into a portion other than the inflation portion connected to the front main chamber MC2, so that the pressure in the front main chamber MC2 is reduced. Therefore, the stress generated in the partition non-inflation portion 112S is reduced by reducing the load applied to the partition non-inflation portion 112S.

### F. Another Embodiment

### F1. Another Embodiment 2-1

In the above-described embodiment, the end part 112Ba of the second non-inflation portion 112B may be formed in a convex shape toward the first non-inflation portion 112A. More specifically, the end part 112Ba of the second non-inflation portion 112B may be in a state of protruding at an interior angle of less than 90 degrees. With such an aspect, the inflation gas IG discharged from the first central orifice MO11 is more likely to flow into the rear sub chamber SC1 along the end part 112Ba of the convex-shaped second non-inflation portion 112B. That is, the pressure in the front main chamber MC2 is further reduced. Therefore, the stress generated in the partition non-inflation portion 112S is reduced by reducing the load applied to the partition non-inflation portion 112S.

### F2. Another Embodiment 2-2

(1) In the above-described embodiment, the curtain airbag device 100 is mounted on the vehicle MV. However, the curtain airbag device 100 may be mounted on a moving body other than the vehicle MV. For example, the curtain airbag device 100 may be mounted on moving bodies other than the vehicle MV such as flying machines or ships.

(2) In the above-described embodiment, the inflation portions such as various main chambers and various sub chambers are surrounded by the plurality of non-inflation portions 112. Alternatively, the inflation portion may be surrounded by one non-inflation portion 112. For example, the inflation portion may be surrounded by one arc-shaped non-inflation portion 112 inside the bag body 110.

(3) In the above-described embodiment, the bag body 110 may include one communication flow path MC1 that allows communication between the front main chamber MC2 and the front sub chamber SC2. Alternatively, the bag body 110 may include a plurality of communication flow paths MC1. Further, the communication flow path MC1 may not function as an inflation portion like the central main chamber MC1. For example, since the front end part 112Sb of the partition non-inflation portion 112S is not connected to the outer peripheral non-inflation portion 1120, the front main chamber MC2 and the front sub chamber SC2 may communicate with each other without passing through the inflation portion. That is, the front sub chamber may include two openings. More specifically, the bag body 110 is provided with two front sub chamber orifices that function as openings of the front sub chamber SC2, and each of the front sub chamber orifices may function as the communication flow path MC1.

(4) In the above-described embodiment, the partition non-inflation portion 112S may not include the arc-shaped section 112Sa2 and the bifurcation section 112Sa1 in the rear end part 112Sa. For example, the rear end part 112Sa may be one non-inflation portion 112 curved in an arc shape.

(5) In the above-described embodiment, the width Wc1 of the first front main chamber orifice CO1 is larger than the width Ws2 of the front sub chamber orifice SO2. Alternatively, the width Wc1 of the first front main chamber orifice CO1 may not be larger than the width Ws2 of the front sub chamber orifice SO2. For example, the width Wc1 of the first front main chamber orifice CO1 may be the same as the width Ws2 of the front sub chamber orifice SO2.

(6) In the above-described embodiment, the width Wc2 of the second front main chamber orifice MO2 is larger than the width Wc1 of the first front main chamber orifice CO1. Alternatively, the width Wc2 of the second front main chamber orifice MO2 may not be larger than the width Wc1 of the first front main chamber orifice CO1. For example, the width Wc2 of the second front main chamber orifice MO2 may be the same as the width Wc1 of the first front main chamber orifice CO1.

(7) In the above-described embodiment, the first non-inflation portion 112A has a shape in which the magnitude of the body opening SP along the width direction Wd is larger than the magnitude of the body opening SP along the direction Vd perpendicular to the width direction Wd. Alternatively, the first non-inflation portion 112A may have a shape in which the magnitude of the body opening SP along the width direction Wd is smaller than the magnitude of the body opening SP along the direction Vd perpendicular to the width direction Wd.

(8) In the above-described embodiment, the bag body 110 includes the central main chamber orifice MO12 as an opening of the central main chamber MC1. Alternatively, the bag body 110 may not include the central main chamber orifice MO12. That is, the bag body 110 may include only the front sub chamber orifice SO2 and the first front main chamber orifice CO1 as the openings of the central main chamber MC1.

(9) In the above-described embodiment, the bag body 110 may not include the rear main chamber MC3 or the rear sub chamber SC1. For example, the bag body 110 may include only the front main chamber MC2 and the front sub chamber SC2. More specifically, since the curtain airbag device 100 is mounted on the vehicle MV having only one row of seats, only the front main chamber MC2 and the front sub chamber SC2 are provided in the bag body 110 to protect only the protection object PO1.

(10) In the above-described embodiment, the bag body 110 may not include the second central orifice SO11. For example, in the bag body 110, the rear sub chamber orifice SO12 may function as the rear orifice CO2 by providing the end part of the third non-inflation portion 112C in the position of the fourth non-inflation portion 112D.

The present disclosure is not limited to the above-described embodiments, and may be implemented by various configurations without departing from the gist of the present disclosure. For example, the technical features in the embodiments corresponding to the technical features in the aspects described in the summary of the present disclosure may be replaced or combined as appropriate to solve a part or all of the above-described problems or to achieve a part or all of the above-described effects. Further, unless the technical features are described as being essential in the present specification, the technical features may be appropriately deleted.

What is claimed is:

1. A curtain airbag device for a moving body, the curtain airbag device comprising:
a bag body that inflates and deploys when being supplied with inflation gas; and
an inner tube that has at least a part arranged in the bag body, is supplied with inflation gas from outside, and controls a flow of inflation gas into the bag body, wherein
the bag body includes
a first inflation chamber that alleviates an impact on a protection object in the moving body when being inflated by inflation gas,
a first orifice through which inflation gas flowing into the first inflation chamber flows,
a first sub chamber that adjusts an inflation way of the first inflation chamber and receives inflation gas, and
a second orifice through which inflation gas flowing into the first sub chamber flows, and
the inner tube has a first inflation chamber opening that is arranged in a position facing the first orifice and discharges inflation gas.

2. The curtain airbag device according to claim 1, wherein
the inner tube further has a first sub chamber opening that is arranged in a position facing the second orifice and discharges inflation gas.

3. The curtain airbag device according to claim 2, wherein
the bag body further includes
a second inflation chamber that alleviates an impact on a protection object in the moving body when being inflated by inflation gas and is arranged forward of the first inflation chamber, and
a third inflation chamber that alleviates an impact on a protection object in the moving body when being inflated by inflation gas and is arranged rearward of the first inflation chamber, wherein
the inner tube further has
a second inflation chamber opening that discharges inflation gas into the second inflation chamber, and
a third inflation chamber opening that discharges inflation gas into the third inflation chamber.

4. The curtain airbag device according to claim 3, wherein
the bag body further includes
a communication orifice that allows communication between the first inflation chamber and the second inflation chamber,
a second sub chamber that receives inflation gas and is connected to the first inflation chamber and has a volume smaller than a volume of the first sub chamber, and
a second sub chamber orifice through which inflation gas flowing into the second sub chamber flows and that is arranged on a side opposite to the first orifice relative to the communication orifice.

5. The curtain airbag device according to claim 4, wherein
the first inflation chamber is located closer to a support pillar supporting at least one of a roof of the moving body and a door of the moving body than the second inflation chamber and the third inflation chamber are in a front-rear direction of the moving body.

6. The curtain airbag device according to claim 4, wherein
a length of the first sub chamber along a flow direction of inflation gas is larger than a width of the second orifice, and
a length of the second sub chamber along a flow direction of inflation gas is larger than a width of the second sub chamber orifice.

7. The curtain airbag device according to claim 2, wherein
a length of the first sub chamber along a flow direction of inflation gas is larger than a width of the second orifice.

8. The curtain airbag device according to claim 6, wherein
the first sub chamber has
a first part extending rearward from a position downward of the inner tube,
a second part arranged downward of the first part and extending rearward from a position downward of the inner tube, and
a third part connecting a rear end of the first part and a rear end of the second part.

9. A curtain airbag device for a moving body, the curtain airbag device comprising:
a bag body that inflates and deploys when being supplied with inflation gas, wherein
the bag body includes a plurality of non-inflation portions that serve as portions to which fabrics that constitute the bag body are joined,
an inflation chamber serving as an inflation portion and a sub chamber respectively surrounded by one or more non-inflation portions among the plurality of non-inflation portions,
a plurality of orifices through which inflation gas to be received in the inflation chamber or the sub chamber flows, and
one or more communication flow paths that allow communication between the inflation chamber and the sub chamber, and
the inflation chamber alleviates an impact on a protection object resulting from coming into contact with the protection object in the moving body by inflating when being supplied with inflation gas,
the sub chamber adjusts an inflation way of the inflation chamber by receiving inflation gas,
the plurality of orifices include one or more sub chamber orifices that allow communication with the communication flow paths, and
the plurality of non-inflation portions include a partition non-inflation portion that partitions the inflation chamber and the sub chamber and is longer than a width of the sub chamber orifice.

10. The curtain airbag device according to claim 9, wherein
the partition non-inflation portion further includes, at an end part of the partition non-inflation portion,
a bifurcation section that bifurcates, and
an arc-shaped section that connects respective distal ends of the bifurcation section.

11. The curtain airbag device according to claim 10, wherein
the sub chamber has only one opening, and
the sub chamber orifice functions as the opening of the sub chamber.

12. The curtain airbag device according to claim 11, wherein
the communication flow path is arranged rearward of the inflation chamber and functions as the inflation portion.

13. The curtain airbag device according to claim 12, wherein
the bag body further includes
a first inflation chamber orifice that serves as an opening of the inflation chamber and allows communication with the communication flow path, among the plurality of orifices, and
a width of the first inflation chamber orifice is larger than the width of the sub chamber orifice.

14. The curtain airbag device according to claim 13, wherein
the bag body further includes
a first non-inflation portion that partially partitions the communication flow path serving as the inflation portion and the inflation chamber, among the plurality of non-inflation portions,
a body opening to which inflation gas is supplied, and
a second inflation chamber orifice that allows communication with the body opening and is partially defined by the first non-inflation portion, among the plurality of orifices, and
a width of the second inflation chamber orifice is larger than the width of the first inflation chamber orifice.

15. The curtain airbag device according to claim 14, wherein
the body opening is an innermost part of the bag body in a flow path connecting outside and inside of the bag body, and is defined by a non-inflation portion outside the bag body, and
the first non-inflation portion has a shape in which a magnitude of the body opening along a width direction is larger than a magnitude along a direction perpendicular to the width direction.

16. The curtain airbag device according to claim 15, wherein
the bag body further includes orifices other than the first inflation chamber orifice and the sub chamber orifice as openings of the communication flow paths serving as the inflation portions, among the plurality of orifices, and
the other orifices allow communication with the body opening.

17. The curtain airbag device according to claim 16, wherein
the communication flow path serving as the inflation portion alleviates an impact on the protection object resulting from coming into contact with the protection object, and
the bag body further includes
an additional sub chamber that adjusts an inflation way of the communication flow path serving as the inflation portion in response to receiving inflation gas, and
a central orifice that is arranged in a position facing the body opening and discharges inflation gas to the communication flow path serving as the inflation portion and the additional sub chamber, and
a second non-inflation portion that partially partitions the communication flow path serving as the inflation portion and the additional sub chamber, among the plurality of non-inflation portions, and
an end part of the second non-inflation portion defines a narrowest part of the other orifices and is arranged within a width range of the central orifice when viewed along a flow direction of inflation gas flowing through the central orifice.

18. The curtain airbag device according to claim 17, wherein
the end part of the second non-inflation portion is formed in a convex shape toward the first non-inflation portion.
